(19) United States
(12) Patent Application Publication
(10) Pub. No.: US 2006/0260125 A1
(43) Pub. Date: Nov. 23, 2006

(54) Method for repairing a gas turbine engine airfoil part using a kinetic metallization process

(76) Inventors: James E. Arnold, New Haven, CT (US); Wayne C. Blake, Wallingford, CT (US)

Correspondence Address: John J. Daniels, Esq, 511 Foot Hills Road, Higganum, CT, 06441, US

(21) Appl. No.: 11/130,496

(22) Filed: May 18, 2005

(51) Int. Cl. B23P 6/00

(52) U.S. Cl. 29/889.1; 29/402.01; 29/402.11

(57) ABSTRACT

A method of repairing a turbine engine airfoil part includes the step of first determining dimensional differences between pre-repaired dimensions of a turbine engine airfoil part and desired post-repair dimensions of the turbine engine airfoil part. The turbine engine airfoil part has a metal alloy substrate. A build-up thickness is determined of coating material that is required to obtain the desired post-repair dimensions of the airfoil part. A high-density coating process is performed to coat the turbine engine airfoil part substrate with a coating material to build-up a thickness of coating material effective to obtain desired finished dimensions after performing a hot isostatic pressing treatment. The high density coating process comprises the steps of accelerating metal particles in an inert carrier gas, and directing the accelerated metal particles onto the turbine engine airfoil part so that high-speed collision of the metal particles causes deformation of the particles resulting in a large increase in the surface area of the particles producing the controlled buildup of a high density coating of the deformed metal particles. The hot isostatic pressing treatment is performed to obtain a post-repair turbine engine airfoil part having the desired post-repair dimensions and having diffusion bonding between the coating material and the turbine engine airfoil substrate.

### BACKGROUND OF THE INVENTION

The present invention pertains to methods for repairing a turbine engine airfoil part. More particularly, the present invention pertains to a method for repairing a gas turbine engine airfoil part using a kinetic metallization process and hot isostatic pressing treatment to form a repaired airfoil part with a selectively built-up coating that is relatively oxide free and affixed to the airfoil part substrate through a tenacious diffusion layer bond.

The present invention can also be used to repair cold section components, and other non-airfoil components on gas turbine engines and other system.

The cold section component of a gas turbine engine includes elements such as a containment ring. The containment ring is typically made of a material such as ams4117 aluminum alloy and is known as 6061 t-6 with the following chemistry 1.0 mg, 0.60 si, 0.28 cu, 0.20 cr. The containment ring is provided annularly around the fan blade assembly. In the event of a fan blade failure, the containment ring is designed to contain the shrapnel effect of the failure thus preventing penetration into the aircraft. A typical containment ring has a diameter of about 96 inches.

During the lifetime of a gas turbine engine, the cold section components of the engine become worn and in need of repair. Wearing can occur due to water collecting on the surface of the cold section component. The form of distress is often local pitting corrosion and foreign object damage.

Attempts have been made to use various methods of welding to repair the cold section components of a gas turbine engine. Conventional methods for repairing the cold section components of a gas turbine engine are limited to minor blending.

Airfoil parts, such as blades and vanes, are critical components in the gas turbine engines that are used to power jet aircraft or for the generation of electricity. Each airfoil part is an individual unit having a root or attachment section and an airfoil section. The airfoil section has specific cordal and length dimensions that define the airfoil characteristics of the part. The root section is engaged with and held by a housing member. A plurality of the airfoil parts are thus assembled with the housing member to form a disc or ring. Blades, which during operation are rotating part, are assembled into and disc. Vane, which remain stationary, are assembled into a nozzle or vane ring. In the operating gas turbine engine the assembled rings and discs, determine the path of the intake, combustion and exhaust gases that flow through the engine.

The airfoil part may be either a rotating component or a non-rotating component of the gas turbine engine. If the part is a rotating component, during operation of the turbine engine the part is subjected to centrifugal forces that exert deforming stresses. These deforming stresses cause creep rupture and fatigue problems that can result in the failure of the part. Non-rotating components, such as vanes, are not subjected to centrifugal forces that exert deforming stresses. However, like the rotating parts, these parts are subjected to other deformation such as from hot gas erosion and/or foreign particle strikes. This deformation results in the alteration of the dimensions of the airfoil section. The alteration of the dimensions of the airfoil section can detrimentally modify the airflow through the gas turbine engine which is critical to the engine's performance.

An example of a non-rotating airfoil part is the 2nd stage vane of the Pratt & Whitney JT8D model 1 through 17R gas turbine engine. This part is manufactured by the “lost wax” or “investment casting” process. The vane is cast from one of several highly alloyed nickel or cobalt-base materials. As a new part in a new gas turbine engine, or as a new spare part in an overhauled engine, it begins its life cycle with a protective diffusion coating on its airfoil surfaces and a wear coating on surfaces known to have excessive wear patterns.

When the gas turbine engine is operating, the vane will see temperatures of about 1500 degree F. Since the vane does not rotate and thus is not subject to creep rupture, its demise is most often influenced by the number of times it is repaired. The reason for this is the repair process itself.

The repair process consists of the following operations:
1). degrease, wash to remove engine carbon, etc.
2.) grit blast to remove wear coatings, and any sulfidation which is present
3.) chemically remove the diffusion coating
4.) blend to remove nicks, dents, etc.
5.) weld, grind, polish etc.

The repair operations that remove metal by chemical stripping, grit blasting, blending and polishing shorten the life cycle of the vane. The coating removal is a major contributor because it is diffused into the parent metal. When certain minimum airfoil dimensions cannot be met the part is deemed non-repairable and must be retired from service. Thus, there is a need for a method for repairing gas turbine engine airfoil parts that effectively and efficiently restores the airfoil dimensions of the part.

On another front, during the manufacture of metal components a coating operation is performed to provide a coating material layer on the surface of a component substrate. The coating material layer is formed to build-up the metal component to desired finished dimensions and to provide the finished product with various surface attributes. For example, an oxide layer may be formed to provide a smooth, corrosion resistant surface. Also, a wear resistant coating, such as Carbide, Cobalt, or TiN is often formed on cutting tools to provide wear resistance.

Chemical Vapor Deposition is typically used to deposit a thin film wear resistant coating on a cutting tool substrate. For example, to increase the service life of a drill bit, chemical vapor deposition can be used to form a wear resistant coating of Cobalt on a high speed steel (HSS) cutting tool substrate. The bond between the substrate and coating occurs primarily through mechanical adhesion within a narrow bonding interface. During use, the coating at the cutting surface of the cutting tool is subjected to shearing forces resulting in flaking off the coating of the tool substrate. The failure is likely to occur at the narrow bonding interface.

FIG. 12(a) is a side view of a prior art tool bit coated with a wear resistant coating. In this case, the wear resistant coating may be applied by the Chemical Vapor Deposition method so that the entire tool bit substrate receives an even thin film of a relatively hard material, such as Carbide, Cobalt or TiN. Since the coating adheres to the tool bit substrate mostly via a mechanical bond located at a boundary interface, flaking and chipping off the coating of the substrate is likely to occur during use, limiting the service life of the tool bit. FIG. 12(b) is a side view of a prior art tool bit having a fixed wear resistant cutting tip. In this case, a relatively hard metal cutting tip is fixed to the relatively soft tool bit substrate. The metal cutting tip, which is typically comprised of a Carbide or Cobalt alloy, is fixed to the tool bit substrate by brazing. During extended use the tool bit is likely to fail at the relatively brittle brazed interface between the metal cutting tip and the tool substrate, and again, the useful service life of the tool bit is limited.

Another coating method, known as Conventional Plasma Spray uses a super heated inert gas to generate a plasma. Powder feedstock is introduced and carried to the workpiece by the plasma stream. Conventional plasma spray coating methods deposit the coating material at relatively low velocity, resulting in voids being formed within the coating and in a coating density typically having a porosity of about 5.0%. Again, the bond between the substrate and the coating occurs primarily through mechanical adhesion at a bonding interface, and if the coating is subjected to sufficient shearing forces it will flake off of the workpiece substrate.

Another coating method, known as the Hyper Velocity Oxyfuel (HVOF) plasma thermal spray process is used to produce coatings that are nearly absent of voids. In fact, coatings can be produced nearly 100% dense, with a porosity of less than 0.5%. In HVOF thermal spraying, a fuel gas and oxygen are used to create a combustion flame at 2500 to 3100° C. The combustion takes place at a very high chamber pressure and a supersonic gas stream forces the coating material through a small-diameter barrel at very high particle velocities. The HVOF process results in extremely dense, well-bonded coatings. Typically, HVOF coatings can be formed nearly 100% dense, with a porosity of <0.5%. The high particle velocities obtained using the HVOF process results in relatively better bonding between the coating material and the substrate, as compared with other coating methods such as the Conventional Plasma spray method or the Chemical Vapor Deposition method. However, the HVOF process also forms a bond between the coating material and the substrate that occurs primarily through mechanical adhesion at a bonding interface.

Detonation Gun coating is another method that produces a relatively dense coating. Suspended powder is fed into a long tube along with oxygen and fuel gas. The mixture is ignited in a controlled explosion. High temperature and pressure is thus created to blast particles out of the end of the tube and toward the substrate to be coated.

An example of using HVOF or Detonation Gun coating techniques is disclosed in U.S. Pat. No. 5,584,663, issued to Schell. This reference discloses that the tips of turbine blades can be formed by melting and fusing a powder alloy. Preferrably, the blade tip is generated by depositing molten metal alloy powder in multiple passes. Squealers at the perimeter of the blade tip may be formed using methods such as Detonation Gun or HVOF spray methods. The forming step may be used to generate a near-net shaped blade tip, and a subsequent machining step may be employed to generate the final or preferred shape of the blade tip.

Kinetic metallization (KM) is another known method for forming a high density coating. It is a solid state process in which metallic powders are sprayed through a sonic deposition nozzle. The particles are accelerated within an inert gas and directed onto a substrate or workpiece. The high speed collision of the metal particles results in very large strain (approximately 80% in the direction normal to impact). This deformation results in a very large increase in surface area, producing a new surface that is oxide free. When the thus-formed active surfaces come into contact, high density, metallic bonding is formed, creating a high density coating without bulk melting (see, Gabel, H., Kinetic Metallization Compared with HVOF, Advanced Materials & Processes/May 2004, ASM International, Metals Park, Ohio, incorporated by reference herein). U.S. Pat. No. 5,795,626, issued to Gabel, et al., describes a KM system using a triboelectric applicator and process for coating or ablating a substrate and for retrieving excess or ejected material from the substrate.

Casting is a known method for forming metal components. Typically, a substrate blank is cast to near-finished dimensions. Various machining operations, such as cutting, sanding and polishing are performed on the cast substrate blank to eventually obtain the metal component at desired finished dimensions. A cast metal component will typically have a number of imperfections caused by voids and contaminants in the cast surface structure. The imperfections may be removed by machining away the surface layer of the component, and/or by applying a surface coating.

The manufacture of metal components often entails costly operations to produce products with the desired surface texture, material properties and dimensional tolerances. For example, a known process for manufacturing a metal component requires, among other steps, making a casting of the metal component, treating the metal component using a Hot Isostatic Pressing (HIP) treatment process, and then machining the metal component to remove surface imperfections and obtain the desired dimensional tolerances.

HIP treatment is used in the densification of cast metal components and as a diffusion bonding technique for consolidating powder metals. In the HIP treatment process, a part to be treated is raised to a high temperature and isostatic pressure. Typically, the part is heated to 0.6-0.8 times the melting point of the material comprising the part, and subjected to pressures on the order of 0.2 to 0.5 times the yield strength of the material. Pressurization is achieved by pumping an inert gas, such as Argon, into a pressure vessel. Within the pressure vessel is a high temperature furnace, which heats the gas to the desired temperature. The temperature and pressure are held for a set length of time, and then the gas is cooled and vented.

The HIP treatment process is used to produce near-net shaped components, reducing or eliminating the need for subsequent machining operations. Further, by precise control of the temperature, pressure and time of a HIP treatment schedule a particular microstructure for the treated part can be obtained. However, traditional HIP treatments are performed at temperatures and pressures that are too elevated for treating relatively articles made of soft metals, such as an aluminum containment ring for a gas turbine engine. Additionally, the traditional HIP treatment vessels are not large enough to handle parts as large as the containment ring of a gas turbine engine.

All casting processes must deal with problems that the wrought processes do not encounter. Major among those are porosity and shrinkage that are minimized by elaborate gating techniques and other methods that increase cost and sometimes lower yield. However, the ability to produce a near-net or net shape is the motivating factor. In some cases, it is more cost effective to intentionally cast the part not using elaborate and costly gating techniques and HIP treat the part to eliminate the sub-surface porosity. The surface of the part is then machined until the dense substrate is reached.

U.S. Pat. No. 5,156,321, issued to Liburdi et al and U.S. Pat. No. 5,071,054, issued to Dzugan et al. are examples of methods that employ the HIP treatment process. Liburdi et al. discloses a technique to repair or join sections of a superalloy article. A powder matching the superalloy composition is sintered in its solid state to form a porous structure in an area to be repaired or joined. A layer of matching powder, modified to incorporate melting point depressants, is added to the surface of the sintered region. Liburdi discloses that the joint is raised to a temperature where the modified layer melts while the sintered layer and base metal remain solid. The modified material flows into the sintered layer by capillary action resulting in a dense joint with properties approaching those of the base metal. This reference discloses that HIPing can be used as part of the heat treatment to close any minor interior defects. Dzugan et al. discloses fabricating a superalloy article by casting, and then refurbishing primary defects in the surface of the cast piece. The defects are removed by grinding. The affected portions of the surface are first filled with a material that is the same composition as the cast article. Then, a cladding powder is applied to the surface through the use of a binder coat to obtain a smooth surface. The article is then heated to melt the cladding powder, and then cooled to solidify. Finally, the article is HIPed to achieve final closure of the surface defects.

Metal alloy components, such as gas turbine parts such as blades and vanes, are often damaged during use. During operation, gas turbine parts are subjected to considerable degradation from high pressure and centrifugal force in a hot corrosive atmosphere. The gas turbine parts also sustain considerable damage due to impacts from foreign particles. This degradation results in a limited service life for these parts. Since they are costly to produce, various repair methods are employed to refurbish damaged gas turbine blades and vanes.

Some examples of methods employed to repair gas turbine blades and vanes include U.S. Pat. No. 4,291,448, issued to Cretella et al.; U.S. Pat. No. 4,028,787, issued to Cretella et al.; U.S. Pat. No. 4,866,828, issued to Fraser; and U.S. Pat. No. 4,837,389, issued to Shankar et al.

Cretella '448 discloses a process to restore turbine blade shrouds that have lost their original dimensions due to wear while in service. This reference discloses using the known process of TIG welding worn portions of a part with a weld wire of similar chemistry as the part substrate, followed by finish grinding. The part is then plasma sprayed with a material of similar chemistry to a net shape requiring little or no finishing. The part is then sintered in an argon atmosphere. The plasma spray process used in accordance with Cretella '448 results in a coating porosity of about 5.0%. Even after sintering the coating remains attached to the substrate and weld material only by mechanical bond at an interface bonding layer making the finished piece prone to chipping and flaking.

Cretella '787 discloses a process for restoring turbine vanes that have lost their original dimensions due to wear while in service. Again, a conventional plasma spray process is used to build up worn areas of the vane before performing a sintering operation in a vacuum or hydrogen furnace. The porosity of the coating, and the interface bonding layer, results in a structure that is prone to chipping and flaking.

Fraser discloses a process to repair steam turbine blades or vanes that utilize some method of connecting them together (i.e. lacing wire). In accordance with the method disclosed by Fraser, the area of a part that has been distressed is removed and a new piece of like metal is welded to the part. The lacing holes of the part are plug welded. The part is then subjected to hot striking to return it to its original contour, and the lacing holes are re-drilled.

Shankar et al. disclose a process for repairing gas turbine blades that are distressed due to engine operation. A low-pressure plasma spray coating is applied to the vanes and the part is re-contoured by grinding. A coating of aluminum is then applied using a diffusion coating process. Again, the conventional low-pressure plasma spray process forms a mechanical bond at an interface boundary between the coating and the substrate, resulting in a structure that is prone to failure due to chipping and flaking.

Other examples of methods for repairing or improving the characteristics of turbine engine airfoil parts include U.S. Pat. No. 5,451,142 issued to Cetel et al.; U.S. Pat. No. 4,921,405, issued to Wilson; U.S. Pat. No. 4,145,481 issued to Gupta et al.; and U.S. Pat. No. 5,732,467 issued to White et al.

Cetel discloses a turbine engine blade having a blade root with a surface having a thin zone of fine grains. A plasma spray technique is used to form a thin layer of material on the root or fir tree portion of the blade. The blade is then HIPed. After the HIP process, the blade is solution heat treated and then machined. This reference is directed to a process for modifying the root section of a turbine blade to improve the mechanical properties of this area of the part. The root section is serrated and is attached to the disc by inserting the root serrations into matching serrations of the disc. The blade is normally produced, as relating to chemistry and microstructure, to maximize the creep rupture and high cycle fatigue properties of the airfoil which is exposed to the hot gas path. The root section of the part thus has those same properties as the airfoil section. However, the root section of the blade is exposed to stress of a type different than the airfoil section, usually referred to as low cycle fatigue. The root section experiences colder operating temperatures than the airfoil section and is not directly in the path of the hot gases that flow through the engine. Also, the root section is subjected to metal to metal stress during rotation resulting in low cycle fatigue cracking. Cetal is concerned with treating only the fir tree or root portion of the blade to improve its mechanical properties. The root portion or a new or refurbished blade is treated with a plasma spray process, HIPing, and a heat treatment and then machined. The blade is machined to remove material from a high stress portion of the blade root. The material removed by the machining operation is replaced by a zone of fine grains by a plasma spray technique. The part is processed through a HIP cycle to densify the deposit, and then a heat treatment cycle to enhance its properties. Finally, the root is machined back to the desired blueprint dimensions and the part returned to service.

Wilson discloses a turbine engine blade having a single crystal body having an airfoil section and an attachment or root section. A layer of polycrystalline superalloy is applied to the attachment section, preferrably by plasma spraying. The coated blade is HIPed and then solution heat-treated to optimize the polycrystalline microstructure.

Grupta discloses a process for producing high temperature corrosion resistant metal articles. A ductile metallic overlay is formed on the surface of an article substrate, and an outer layer is applied over the overlay. The article is then subjected to a HIP treatment to eliminate porosity and create an inter-diffusion between the outer layer the overlay and the substrate.

U.S. Pat. No. 5,318,217, issued to Stinson et al, teaches a method for enhancing the structural integrity of a bond joint in a spray cast article. In this reference, a molten metal is spray cast onto a metal substrate and treated by vacuum cleaning, boronizing and/or knurling to enhance the structural integrity of a diffusion bond joint formed by a HIP treatment. U.S. Pat. No. 5,211,776, issued to Weiman teaches that a metal and ceramic matrix composite can be formed by the successive building up of layers. An optional HIP or diffusion annealing process can be performed to improve the properties of the composite.

None of these prior attempts provide for the effective and efficient restoration of the critical airfoil dimensions of a gas turbine engine airfoil part. Typically, an airfoil part will have to be discarded after it has gone through a certain number of repair cycles. The stripping of the protective coating on the part during the repair process is a major contributing factor resulting in the discarding of the part. After a number of repair cycles the part simply does not have the minimum dimensional characteristics necessary for it to perform its intended function. Therefore, there is a need for a method for repairing gas turbine engine airfoil parts that effectively and efficiently restores the critical airfoil dimensions of the part.

Turbine engine airfoil parts, such as vanes, are manufactured to precise tolerances that determine the airflow characteristics for the part. The class of a turbine vane is the angular relationship between the airfoil section and the inner and outer buttresses of the vane. This angular relationship has a direct bearing on the angle of attack of the airfoil section during the operation of the gas turbine engine. Over time, the angular relationship between the airfoil section and the inner and outer buttresses of the vane may become altered due to, for example, deformation of the airfoil section from engine operation and repair processes and the like. Or, the particular angular relationship of the airfoil section and the inner and outer buttresses as originally manufactured may need to be changed to improve engine performance. In any event, there is a need for a method of restoring or reclassifying a gas turbine engine airfoil part.

Airfoil parts, such as blades, are critical components in the gas turbine engines that are used to power jet aircraft or for the generation of electricity. As shown in FIG. 23(a), each blade 38 is an individual unit having a shroud section 40 and an airfoil section 42. The airfoil section 42 has specific cordal and length dimensions that define the airfoil characteristics of the part. The shroud section 40 is engaged with and held by an annular housing member (not shown). A plurality of interlocking blades are thus assembled with the housing member to form a disc. In the operating gas turbine engine the assembled discs, which are rotating parts, determine the path of the intake, combustion and exhaust gasses that flow through the engine.

FIG. 23(b) shows two adjacent blades 38 of an assembled disc. The blades are held in the housing member (not shown) such that surfaces 44 of each shroud section 40 contacts corresponding surfaces 44 of adjacent shrouds. These contact surfaces 44 are subjected to wearing forces during the operation of the gas turbine engine. As an assembled disc of blades rotates, the individual adjacent blades 38 may chatter against each other, causing wear to occur at the contact surfaces 46 of the shroud sections 38. This chattering results in constant hammering at the contact surfaces 44 of the interlocking blades 38. Excessive wear in the area of the contact surfaces 44 can have detrimental consequences on the operation of the gas turbine engine, and thus is an area of concern.

To combat the excessive wear in the area of the contact surfaces of the shrouds, it has been conventional practice to apply a hard facing material to the shroud in the location of the contact surfaces. FIG. 23(a) shows a typical location for the application of a hard facing material 46. The hard facing material is applied to the shroud by, for example, manual tig welding or laser welding.

As disclosed in co-owned US patent applications and as disclosed herein, applicants have invented methods for creating a diffusion bonded coating on the surface of a workpiece, such as a turbine engine airfoil part. These co-owned applications include a application Ser. No. 10/638,192, which is a Continuation-in-Part of application Ser. No. 10/423,722, filed Apr. 28, 2003, which is a Continuation-in-Part of application Ser. No. 10/241,854, filed Sep. 13, 2002, which is a Continuation-in-Part of application Ser. No. 09/505,803, filed Feb. 17, 2000, which is a Continuation-in-Part of application Ser. No. 09/143,643, filed Sep. 3, 1998, now U.S. Pat. No. 6,049,978, which is a Continuation-in-Part of application Ser. No. 08/993,116, now U.S. Pat. No. 5,956,845, which is the utility patent application of a U.S. provisional application Ser. No. 60/033,858, filed Dec. 23, 1996; and relates to an invention disclosed in an Invention Disclosure Document accepted under the Disclosure Document program on or about Nov. 5, 1996 and assigned Disclosure Document No. 407616.

In accordance with the invention described in applicants co-pending U.S. patent application, Ser. No. 10/021,107, which is incorporated by reference herein, a cobalt-based alloy is provided that is particularly useful as a hard facing material for gas turbine engine components, such as the shrouds of a gas turbine engine blade. The alloy compositions as described in this co-pending application have a relatively small lanthanum addition and relatively large carbon content and provide remarkable oxidation resistance and wear resistance at high temperatures. Importantly, the inventive alloy composition has a suitable combination of ductility and wear resistance at high temperatures to be effective as a hard face material for limiting the effects of chattering of blades during the operation of a gas turbine engine. Accordingly, the inventive alloy has a suitable combination of ductility, oxidation resistance and wear resistance and thus represents an improved hard facing material for the blade components of gas turbine engine.

A conventional hard facing material for use on the blade of gas turbine engines consists of an alloy containing chromium, tungsten, nickel and cobalt. U.S. Pat. No. 3,265,434, issued to Baldwin, teaches an alloy for high temperature use containing chromium, tungsten, nickel and cobalt. Baldwin specifically teaches an alloy with improved short time tensile strength at 1800° F., wherein the ratio of cobalt to chromium is always at least 1.4:1. Baldwin further teaches that an alloy with optimum characteristics, from the standpoint of a combination of ductility (freedom from brittleness), and wear resistance, were obtained with a nickel content in the range of 4 to 6%. The composition taught by Baldwin has a short time tensile strength at 1800° F. of 48,000 p.s.i.

U.S. Pat. No. 3,582,320, issued to Herchenroeder, teaches a cobalt base alloy having superior oxidation and wear resistance. Herchenroeder teaches that a relatively small lanthanum addition and a relatively large carbon content provides remarkable oxidation resistance and wear resistant properties at high temperatures. The composition taught by Herchenroeder has an ultimate tensile strength of 15,700 p.s.i.

U.S. Pat. No. 3,947,269, issued to Prasse et al., teaches a boron-hardened tungsten facing alloy used as a facing or coating for base material, and in particular as a piston ring facing. The alloy taught be Prasse et al. is applied as a metal powder that is melted and sprayed upon a workpiece, such as a piston ring of a high compression combustion engine.

U.S. Pat. No. 4,822,248, issued to Wertz et al., teaches a method of rebuilding a shroud of a turbine blade. A wear resistant overlay is formed using a plasma torch. A powdered metal is applied to the notch of a shroud and a plasma transferred arc is generated at low amperage sufficient to melt and cast the powdered metal while holding the heat imparted to the shroud to a minimum.

To be effective for use in the demanding environments subjected to the blades in an operating gas turbine engine, a hard facing material must have superior oxidation and wear resistance at elevated temperatures. Further, the hard facing material must have a suitable degree of ductility to withstand the constant hammering caused by chattering blades. As shown in FIG. 23(b), the contact surfaces 44 of the shrouds are subjected to wearing forces during the operation of the gas turbine engine. As an assembled disc of blades rotates, the individual adjacent blades 38 may chatter against each other, causing wear to occur at the contact surfaces 44 of the shroud sections 40. This chattering results in constant hammering at the contact surfaces 44 of the interlocking blades 38. Excessive wear in the area of the contact surfaces 44 caused by chipping and flaking can have detrimental consequences on the operation of the gas turbine engine. Accordingly, there is a need for a method for forming a wear-resistant hard-face contact area on a workpiece, such as a gas turbine engine part that is subjected to failure due to chipping or flaking.

### SUMMARY OF THE INVENTION

The present invention overcomes the drawbacks of the conventional. It is an object of the present invention to provide a method is provided for repairing a component of a gas turbine engine.

The present invention pertains to a method of repairing a turbine engine airfoil part is provided that uses kinetic metallization to form a high density coating. This high density coating is capable of being HIP treated so as to form a diffusion bond between the repaired part the applied coating. The significant reduction or elimination of oxides formed using kinetic metallization results in an improved repaired turbine engine airfoil part, at a cost savings as compared with other methods for forming an oxide coating, which typically require the use of a costly vacuum chamber.

In accordance with this aspect of the present invention, a method of repairing a turbine engine airfoil part includes the step of first determining dimensional differences between pre-repaired dimensions of a turbine engine airfoil part and desired post-repair dimensions of the turbine engine airfoil part. The turbine engine airfoil part has a metal alloy substrate. A build-up thickness is determined of coating material that is required to obtain the desired post-repair dimensions of the airfoil part. A high-density coating process is performed to coat the turbine engine airfoil part substrate with a coating material to build-up a thickness of coating material effective to obtain desired finished dimensions after performing a hot isostatic pressing treatment. The high density coating process comprises the steps of accelerating metal particles in an inert carrier gas, and directing the accelerated metal particles onto the turbine engine airfoil part so that high-speed collision of the metal particles causes deformation of the particles resulting in a large increase in the surface area of the particles producing the controlled buildup of a high density coating of the deformed metal particles. The hot isostatic pressing treatment is performed to obtain a post-repair turbine engine airfoil part having the desired post-repair dimensions and having diffusion bonding between the coating material and the turbine engine airfoil substrate.

In accordance with another aspect of the present invention a method is provided for repairing a cold section component of a gas turbine engine. A cold section component includes an engine component known as a containment ring. A containment ring is typically made of a material such as ams 4117 aluminum alloy and is known as 6061 t-6 with the following chemistry 1.0 mg, 0.60 si, 0.28 cu, 0.20 cr. In the event of a fan blade failure the containment ring is designed to contain the shrapnel effect of the failure thus preventing penetration into the aircraft. A typical containment ring has a diameter of about 96 inches.

In accordance with the present invention, a method is provided of repairing a cold section component, such as a containment ring, for a gas turbine engine. A hot isostatic pressure treatment vessel is provided for performing a HIP treatment on a containment ring of a gas turbine engine. The treatment vessel is constructed so that it defines an interior chamber volume. The interior chamber volume has dimensions and geometry that are substantially the same as the dimensions and geometry of a containment ring that is to be repaired. A high-density coating is formed on at least a portion of the containment ring. As described elsewhere herein, the high-density coating is a coating that is effective for form a diffusion boundary with the coated substrate during a hot isostatic pressing heat treatment.

The coated containment ring is disposed in the interior chamber volume. The interior chamber volume is filled with an inert gas, such as argon. The interior volume chamber is raised to a temperature effective to bring the coating into a plastic state. The argon gas in the interior volume is then maintained at a temperature and pressure effective to form a diffusion boundary between the coating and the containment ring substrate. The pressure range is between 15 PSI and 30 KPSI, depending on the composition of the part being repaired and the composition of the high-density coating. By this inventive method, it is now possible to perform a repair operation on a large article, comprised of a relatively soft metal, such as aluminum. An example of an article that can be repaired in accordance with the inventive method is the containment ring of a gas turbine engine.

A sintering heat treatment step can be performed prior to forming the diffusion boundary between the coating and the containment ring substrate. The sintering heat treatment step is performed to prevent the formation of bubbles on the surface of the containment ring after the HIP treatment. The sintering heat treatment may also facilitate the ultimate formation of a tenacious diffusion boundary attachment of the coating material to the repair article substrate.

In accordance with the present invention, the dimensions and geometry of the interior chamber volume is slightly larger than containment ring. This enables a minimum of argon to be needed to fill the volume, while still providing for the appropriate heated gas applied pressure and temperature necessary for forming a diffusion boundary. For example, in the case of a containment ring, the interior chamber defines a ring shape. The hot isostatic pressure chamber thus includes an interior core surrounded by the interior chamber volume and an exterior housing surrounding the interior chamber. Either or both of the interior core and the exterior housing may include hollow structures for allowing a fluid to flow through and control heating and cooling rates of the interior chamber volume. For example, a temperature controlled fluid jacket can be provided for the controlled cooling of the containment ring after the HIP treatment or a subsequent heat treatment step, such as annealing.

The gas in the interior volume may be maintained at a temperature and pressure by providing an oven. The oven has a heating chamber with dimensions and geometry effective to receiving the hot isostatic treatment vessel. The heating of the heating chamber if controlled so that the gas in the interior volume is raised and maintained at the temperature and pressure effective to form the diffusion boundary.

In accordance with another aspect of the present invention, a method of correcting the dimensional characteristics of a cast article is provided. The dimensional differences are determined between pre-repair cast article dimensions and desired post repair cast article dimensions to correct a casting defect in the article. The determination may be made by determining the location and approximate volume of a void in the surface of the article. The determination may also be made by determining an amount of buildup volume required to make at least a portion of the surface of the cast article built up to the desired post repair dimensions. The article is coated in at least an area of the casting defect with a high-density coating material. Depending on the coating process, the coating can be formed in a vacuum, inert atmosphere or under ambient conditions. How ever it is applied, in accordance with the invention, the coating must be capable of forming a diffusion boundary between the coating material and the article. A hot isostatic heat treatment process is performed to form the diffusion boundary between the coating material and the article.

Depending on the type of casting defect, material in an area of the casting defect may be removed before the step of coating the article. For example, if the casting defect is an inclusion of an undesired composition, such as an oxide or dirt particle, the inclusion and some of the base article material can be removed by a machining or other operation. The area of the casting defect is enlarged, and may be contoured to create a better surface for holding the coating material. The casting defect may be caused, for example, by at least one of an inclusion at a surface of the article, an air bubble at the surface of the article, undercasting, a void and shrinkage. A sintering heat treatment can be performed before the step of performing the hot isostatic heat treatment to limit the occurrence of bubbles on the surface of the coating material after an isostatic heat treatment. The sintering heat treatment may be performed at a temperature substantially the same as the temperature of the hot isostatic heat treatment.

In accordance with the present invention, the coating material may comprise an alloy with substantially no oxide forming constituents so as to avoid the formation of oxide inclusions in the coating material. In this case, the coating material may be applied using a coating process that is effective to create a coating on the surface of the article that will be diffusion bonded to the article after the hot isostatic heat treatment.

In accordance with the present invention, a method is provided for applying a protective coating to a metal article. A metal article is provided and coated with a high-density coating material capable of forming a diffusion boundary between the coating material and the article. In accordance with this aspect of the invention, the coating material comprises an alloy with substantially no oxide forming constituents so as to avoid the formation of oxide inclusions in the coating material. Applicants have discovered that the oxides in the coating may form crack initiation sites, and cracks formed due to the oxides may propagate through the diffusion boundary and into the article substrate. By limiting the formation of oxides in the coating, these crack initiation sites are reduced or eliminated, thereby enabling the coating material to act as a protective coating. Depending on the coating process, the coating may be applied in a vacuum, under an inert atmosphere or under ambient conditions. In the case of ambient conditions in which oxygen may be present, the coating material may be composed of constituents that substantially avoid the formation of oxide particles, even when oxygen is present. Stated otherwise, the coating material has a chemistry that does not result in crack producing elements, such as oxides, located in the coating and in the diffusion boundary between the coating and the substrate.

The hot isostatic heat treatment process is performed to form the diffusion boundary between the coating material and the article. Thus, in accordance with this aspect of the invention, the substantially oxide free coating and the diffusion boundary provide a protective coating to protect the article from damage.

A sintering heat treatment can be performed before the step of performing the hot isostatic heat treatment to limit the occurrence of bubbles on the surface of the coating material after an isostatic heat treatment. The sintering heat treatment may be performed at a temperature substantially the same as the temperature of the hot isostatic heat treatment. The sintering heat treatment increases the production yield by significantly reducing the formation of bubbles on the surface of the coating due to the hot isostatic heat treatment, etc.

In accordance with another aspect of the invention, a method is provided for repairing a turbine engine airfoil part. The dimensional differences are determined between pre-repair airfoil dimensions of a turbine engine airfoil part substrate and desired post repair airfoil dimensions of the turbine engine airfoil part substrate. The pre-repair airfoil dimensions having different airfoil characteristics than the post-repair airfoil dimensions. The turbine engine airfoil part being comprised of a metal alloy. The engine airfoil part is coated with a coating capable of forming a diffusion boundary with the turbine engine airfoil part substrate. The coating material comprises an alloy with substantially no oxide forming constituents so as to avoid the formation of oxide inclusions in the coating material. A hot isostatic heat treatment process is performed to obtain a post-repair turbine engine airfoil part having the desired post-repair dimensions and having a substantially oxide free coating and diffusion bonding between the coating material and the turbine engine airfoil part substrate. The substantially oxide-free coating provides a protective coating to protect the article from damage. A sintering heat treatment can be performed before the step of performing the hot isostatic heat treatment to limit the occurrence bubbles on the surface of the coating material after an isostatic heat treatment. The sintering heat treatment may be performed at a temperature substantially the same as the temperature of the hot isostatic heat treatment.

In accordance with the present invention, a method is provided for forming a diffusion coating on the surface of a workpiece. A workpiece substrate is provided. A coating is formed on at least one of the selected portions of the workpiece substrate. The coating material is capable of forming a diffusion bond with the workpiece substrate. The diffusion bond is a metallurgical bond between the workpiece and the coating that does not have an interface boundary. This diffusion bond creates a secure attachment between the coating and the substrate, much stronger than the mechanical bond that is originally formed between the coating and the substrate. A sintering heat treatment is first performed to expel trapped gas from the coating material. Applicant has found that the entrapped gas is problematic because it results in a weaker, bubbled surface with an inconsistent diffusion bond between the coating and the substrate. The sintering heat treatment removes the entrapped gas and prevents outgassing of the trapped gas during a hot isostatic pressing treatment. This preventive treatment has been experimentally proven to greatly reduces the formation of bubbles on the surface of the coated workpiece after the hot isostatic pressing treatment. After the entrapped gas is removed by the sintering heat treatment, the hot isostatic pressing treatment is then performed to drive the coating material into the workpiece substrate. The hot isostatic pressing treatment results in the formation of the diffusion bond so that the metallurgical bond between the workpiece and the coating is formed.

A method of correcting defects in a metal workpeice. A location of a defect in a workpiece is determined. The defect comprising a void or an inclusion in a workpiece substrate. The workpiece substrate is comprised of a metal alloy. Material of the workpiece substrate at the location of the defect is removed to form a cleaned area in the workpiece substrate. The cleaned area in the workpiece substrate is coated with a high-density coating. A sintering heat treatment is performed on the coated workpiece substrate to remove entrapped gas from the coating material prior to a step of hot isostatic pressing treatment. Then, hot isostatic pressing treatment is performed on the coated workpiece to produce diffusion bonding between the workpiece substrate and the high-density coating. The material can be removed by techniques such as sandblasting or grinding. A high-density coating process such as hyper-velocity oxy-fuel thermal spray process or a detonation gun process is used to apply the high-density coating to the substrate at the location of the cleaned area. The high-density coating may have the same metal alloy composition as the metal alloy substrate. The metal alloy substrate may comprise a nickel or cobalt-based superalloy, and the high-density coating may have the same nickel or cobalt-based super alloy composition as the metal alloy substrate.

The workpiece substrate is prepared for a high-density coating process. The preparation may include cleaning, blasting, machining, masking or other like operations. Once the workpiece substrate has been prepared, a high-density coating process is performed to coat the workpiece substrate. The coating material is built-up to a thickness that is effective to obtain desired finished dimensions after performing a hot isostatic pressing treatment (described below). The high-density coating process may comprise performing a hyper velocity oxy-fuel thermal spray process. In the case of HVOF, a fuel gas and oxygen are used to create a combustion flame at 2500 to 3100° C. The combustion takes place at a very high chamber pressure and a supersonic gas stream forces the coating material through a small-diameter barrel at very high particle velocities. The HVOF process results in extremely dense, well-bonded coatings. Typically, HVOF coatings can be formed nearly 100% dense, with at a porosity of about 0.5%. The high particle velocities obtained using the HVOF process results in relatively better bonding between the coating material and the substrate, as compared with other coating methods such as the conventional plasma spray method or the chemical vapor deposition method. However, the HVOF process forms a bond between the coating material and the substrate that occurs primarily through mechanical adhesion at a bonding interface. As will be described below, in accordance with the present invention this mechanical bond is converted to a metallurgical bond by creating a diffusion bond between the coating material and the workpiece substrate. This diffusion bond does not have the interface boundary which is usually the site of failure.

The diffusion bond is created by subjecting the coated workpiece substrate (or, in the case of the inventive repair method, the coated airfoil part) to a hot isostatic pressing (HIP) treatment. The appropriate hot isostatic pressing treatment parameters are selected depending on the coating, the workpiece substrate and the final attributes that are desired. The hot isostatic pressing treatment is performed on the coated workpiece substrate to obtain a metal product having the desired finished dimensions and diffusion bonding between the coating material and the workpiece substrate.

HIP treatment is conventionally used in the densification of cast metal components and as a diffusion bonding technique for consolidating powder metals. In the HIP treatment process, a part to be treated is raised to a high temperature and isostatic pressure. Typically, the part is heated to 0.6-0.8 times the melting point of the material comprising the part, and subjected to pressures on the order of 0.2 to 0.5 times the yield strength of the material. Pressurization is achieved by pumping an inert gas, such as Argon, into a pressure vessel. Within the pressure vessel is a high temperature furnace, which heats the gas to the desired temperature. The temperature and pressure is held for a set length of time, and then the gas is cooled and vented.

In accordance with the present invention, the HIP treatment process is performed on a HVOF coated substrate to convert the adhesion bond, which is merely a mechanical bond, to a diffusion bond, which is a metallurgical bond. In accordance with the present invention, an HVOF coating process is used to apply the coating material having sufficient density to effectively undergo the densification changes that occur during the HIP process. After the HVOF spray material is applied, a sintering heat treatment process can be performed to further densify the coating to prevent gas entrapment of the coating material and/or the diffusion bonding area during the hot isostatic pressing process. If the coating material and the workpiece substrate are comprised of the same metal composition, then the diffusion bonding results in a particularly seamless transition between the substrate and the coating.

The inventive method can be used for forming a metal product having a wear resistant surface. This method can be employed to produce, for example, a long lasting cutting tool from a relatively inexpensive cutting tool substrate. In accordance with this aspect of the invention, a workpiece substrate is formed to near-finished dimensions. A high-density coating process, such as a hyper velocity oxy-fuel thermal spray process, is performed to coat the workpiece substrate with a wear resistant coating material. The coating material is built-up to a thickness that is effective to obtain desired finished dimensions after performing a hot isostatic pressing treatment. A sintering heat treatment step may be performed to improve the density of the coating material and prevent gas entrapment during the hot isostatic pressing treatment. The hot isostatic pressing treatment is performed on the coated workpiece substrate to obtain a metal product having the desired finished dimensions and diffusion bonding between the coating material and the workpiece substrate.

The inventive method can also be used for forming a cast metal product. This method can be employed to produce, for example, a cast part having a hard and/or smooth surface. In accordance with the present invention, a part is cast to dimensions to less than the finished dimensions, or a cast part is machined to less than the finished dimensions. The cast part is then coated using the HVOF coating method as described herein. The HVOF coating is applied to a thickness sufficient to bring the part to its finished dimensions. The HVOF coated, cast part is then HIP treated as described herein to obtain a finished part having desired dimensions and surface characteristics.

In accordance with this aspect of the invention, a cast metal workpiece is provided. The cast metal workpiece may be formed from any conventional casting method such as: investment, sand and resin shell casting.

The cast metal workpiece is machined, if necessary, to near-finished dimensions. A high-density coating process, such as a hyper velocity oxy-fuel thermal spray process (HVOF), is performed to coat the workpiece substrate with a coating material. The coating material is built-up to a thickness effective to obtain desired finished dimensions after performing a hot isostatic pressing treatment. A sintering heat treatment step may be performed to improve the density of the coating material and prevent gas entrapment during the hot isostatic pressing treatment. The hot isostatic pressing treatment is performed on the coated workpiece substrate to obtain a metal product having the desired finished dimensions and diffusion bonding between the coating material and the workpiece substrate.

In accordance with another aspect of the present invention, the reclassification of a gas turbine engine airfoil part is obtained. The dimensional differences between pre-reclassified dimensions of the buttresses of a turbine engine airfoil part and desired post-reclassified dimensions of the buttresses are determined. That is, the change in shape of the inner buttress and outer buttress necessary to obtain a desired angular relationship between the airfoil section and the buttresses is determined. Build-up thickness of coating material required to obtain the desired post-reclassified dimensions of the buttresses is determined. A high-density coating process, such as HVOF, is used to coat the buttresses of the turbine engine airfoil part with a coating material. The portions of the part that are not to be built up, such as the airfoil section and parts of the buttresses, may be masked before applying the high-density coating. Also, some of the coated surfaces of the part may need to be built up more than others. The coating material is applied to the determined build-up thickness of coating material effective to obtain the desired post-reclassification dimensions after performing a hot isostatic pressing treatment, and after the selective removal of some of the original buttress material and some of the built up coating material. A sintering heat treatment may be performed before the hot isostatic pressing treatment.

As discussed herein, the coating material comprises a metal alloy capable of forming a diffusion bond with the substrate of the turbine engine airfoil part. After the coating material is applied, the sintering heat treatment process may be performed to prevent gas entrapment of the coating material and/or the diffusion bonding area during the hot isostatic pressing process. Then, the hot isostatic pressing (HIP) process is performed so that the buttresses of the turbine engine airfoil part have a robust diffusion bonding between the coating material and the original material of the buttresses. Having built up the appropriate dimensions of the inner buttress and outer buttress, the reclassification of the part is obtained by selectively removing the original buttress material and, if necessary, some of the built up material until the angular relationship between the airfoil section and the inner and outer buttresses is obtained. The material can be removed through milling, grinding, or other suitable and well known machining operations. Further, to facilitate obtaining the correct dimensions the centerline position of the airfoil part can be located and held by mounting the part in a suitable holding fixture when machining the buttresses.

The fixture may be so constructed so that a vane that has at least a minimum amount of material built up on its buttresses can be machined and reclassified. In this case, it may not be necessary to determine the dimensional differences or the required build-up thickness. Rather, the inventive high-density coating and HIPing process (and, if needed sintering) can be performed to build up at least the minimum amount of material diffusion bonded to the buttresses. Then, the vane is placed in the fixture and the excess material (both original buttress material and the built-up material) is machined until the buttresses have been reshaped and the vane reclassified as intended.

In accordance with another aspect of the present invention, a method is provided for forming a wear-resistant hardfaced contact area on the shroud section of a gas turbine engine blade. A predetermined contact area of a shroud section of a gas turbine engine blade is selectively coated with a high-density hardface coating material. The hardface coating material is capable of forming a diffusion boundary between the hardface coating material and the shroud section. A hot isostatic heat treatment process is performed to form the diffusion boundary between the hardface coating material and the shroud section to form a wear-resistant hardfaced contact area diffusion bonded to the shroud section.

Depending on the coating process, and the necessity for doing so, the predetermined contact area can be masked off before the step of selectively coating. A sintering heat treatment can be perfomed before the step of performing the hot isostatic heat treatment to limit the occurrence of bubbles on the surface of the hardface coating material after the isostatic heat treatment step. The sintering heat treatment may be performed at a temperature substantially the same as the temperature of the hot isostatic heat treatment. The hardface coating material may comprise an alloy with substantially no oxide forming constituents so as to avoid the formation of oxide inclusions in the coating material.

### BRIEF DESCRIPTION OF THE DRAWINGS

FIG. 1(a) is a flow chart showing the steps of the inventive method for repairing a gas turbine engine airfoil part;

FIG. 1(b) is a flow chart showing the steps of the inventive method of forming metal products and metal components having a wear resistant coating;

FIG. 1(c) is a flow chart showing the steps of the inventive method for correcting defects in a workpiece;

FIG. 2(a) is a schematic view of a tool substrate provided in accordance with the inventive method of forming metal components having a wear resistant coating;

FIG. 2(b) is a schematic view of the tool substrate having a wear resistant coating applied using an HVOF thermal spray process in accordance with the inventive method of treating metal components having a wear resistant coating;

FIG. 2(c) is a schematic view of the HVOF spray coated tool substrate undergoing a HIP treatment process in a HIP vessel in accordance with the inventive method of forming metal components having a wear resistant coating;

FIG. 2(d) is a schematic view of the final HVOF spray coated and HIP treated tool having a wear resistant coating layer diffusion bonded to the tool substrate in accordance with the inventive method of forming metal components having a wear resistant coating;

FIG. 3(a) is a schematic perspective view of a cast metal component undergoing a machining operation in accordance with the inventive method of forming a metal product;

FIG. 3(b) is a schematic perspective view of the machined cast metal component in accordance with the inventive method of forming a metal product;

FIG. 3(c) is a schematic perspective view of the machined cast metal component having a coating applied using an HVOF thermal spray process in accordance with the inventive method of forming a metal product;

FIG. 3(d) is a schematic perspective view of the HVOF spray coated machined cast metal component undergoing a HIP treatment process in a HIP vessel in accordance with the inventive method of forming a metal product;

FIG. 3(e) is a schematic perspective view of the final HVOF spray coated and HIP treated machined cast metal product having a coating layer diffusion bonded to the machined cast metal component in accordance with the inventive method of forming a metal product;

FIG. 4 is a flow chart showing the steps of the inventive method of repairing a turbine engine part;

FIG. 5(a) is a schematic side view of a worn turbine engine part before undergoing the inventive method of repairing a turbine engine part;

FIG. 5(b) is a schematic cross-sectional view of the worn turbine engine part before undergoing the inventive method of repairing a turbine engine part;

FIG. 6(a) is a schematic side view of the worn turbine engine part showing the worn areas to be repaired using the inventive method of repairing a turbine engine part;

FIG. 6(b) is a schematic cross-sectional view of the worn turbine engine part showing the worn areas to be repaired using the inventive method of repairing a turbine engine part;

FIG. 7(a) is a schematic side view of the worn turbine engine part showing the worn areas filled in with similar weld material in accordance with the inventive method of repairing a turbine engine part;

FIG. 7(b) is a schematic cross-sectional view of the worn turbine engine part showing the worn areas filled in with similar weld material in accordance with the inventive method of repairing a turbine engine part;

FIG. 8(a) is a schematic side view of the welded turbine engine part showing areas to be built up with similar coating material using an HVOF spray coating process in accordance with the inventive method of repairing a turbine engine part;

FIG. 8(b) is a schematic cross-sectional view of the welded turbine engine part showing areas to be built up with similar coating material using an HVOF spray coating process in accordance with the inventive method of repairing a turbine engine part;

FIG. 9(a) is a schematic side view of the HVOF built up, welded turbine engine part showing an area masked before performing the HVOF spray coating process in accordance with the inventive method of repairing a turbine engine part;

FIG. 9(b) is a schematic cross-sectional view of the HVOF built up, welded turbine engine part in accordance with the inventive method of repairing a turbine engine part;

FIG. 10 is a schematic view of the HVOF built up, welded turbine engine part undergoing a HIP treatment process in a HIP vessel in accordance with the inventive method of repairing a turbine engine part;

FIG. 11(a) is a schematic side view of the final HVOF spray coated and HIP repaired turbine engine part having a similar metal coating layer diffusion bonded to the original parent substrate and welded portions in accordance with the inventive method of repairing a turbine engine part;

FIG. 11(b) is a schematic cross-sectional view of the final HVOF spray coated and HIP repaired turbine engine part having a similar metal coating layer diffusion bonded to the original parent substrate and welded portions in accordance with the inventive method of repairing a turbine engine part;

FIG. 12(a) is a side view of a prior art tool bit coated with a wear resistant coating;

FIG. 12(b) is a side view of a prior art tool bit having a fixed wear resistant cutting tip;

FIG. 13 is a flow chart showing the steps of the inventive method for reclassifying a gas turbine engine airfoil part;

FIG. 14(a) is a front view of a vane from a gas turbine engine showing the airfoil section, the outer buttress and the inner buttress;

FIG. 14(b) is a partial top view of the vane shown in FIG. 14(a) showing the outer buttress and angle α indicating the angular relationship between the airfoil and the outer buttress;

FIG. 14(c) is a partial bottom view of the vane shown in FIG. 14(a) showing the inner buttress and angle α′ indicating the angular relationship between the airfoil and the inner buttress;

FIG. 14(d) is a partial left-side view of the vane shown in FIG. 14(a) showing the leading edge foot of the inner buttress and the outer foot front face of a buttress rail of the outer buttress;

FIG. 14(e) is a partial right-side view of the vane shown in FIG. 14(a) showing the trailing edge foot of the inner diameter buttress and the other buttress rail of the outer diameter buttress;

FIG. 15(a) is a flowchart showing the steps of the inventive method for repairing a workpiece with an electroplated coating diffusion bonded to the workpiece;

FIG. 15(b) is a flow chart showing the steps of the inventive method for repairing a gas turbine engine airfoil part with an electroplated coating diffusion bonded to the airfoil substrate;

FIG. 15(c) is a flow chart showing the steps of the inventive method for correcting defects in a workpiece with an electroplated coating diffusion bonded to the workpiece;

FIG. 15(d) is a flow chart showing the steps of the inventive method for reclassifying a gas turbine engine airfoil part with an electroplated coating diffusion bonded to the airfoil part;

FIG. 16(a) shows an airfoil part prepared for electroplating;

FIG. 16(b) shows the prepared airfoil part being electroplated;

FIG. 16(c) shows the electroplated airfoil part undergoing a sintering heat treatment;

FIG. 16(d) shows the sintered electroplated airfoil part undergoing a hot isostatic heat treatment;

FIG. 16(e) shows the finished airfoil part having a diffusion bond between the electroplated areas and the airfoil substrate;

FIG. 17 illustrates the steps of correcting the dimensional characteristics of a cast article;

FIG. 18 is a flow chart showing the steps of the inventive method of correcting the dimensional characteristics of a cast article;

FIG. 19 schematically illustrates a coated substrate wherein the coating material is diffusion bonded to the substrate and includes an oxide inclusion;

FIG. 20 schematically illustrates the coated substrate shown in FIG. 19 wherein a crack is forming at the site of the oxide inclusion;

FIG. 21 schematically illustrates the coated substrate shown in FIG. 19 wherein the crack formed at the site of the oxide inclusion propagates through the diffusion boundary and into the substrate;

FIG. 22(a) is a schematic perspective view of a cast turbine engine airfoil part showing a casting defect;

FIG. 22(b) is a schematic perspective view of the cast turbine engine airfoil part having the area of the casting defect being machined;

FIG. 22(c ) is a schematic perspective view of the cast turbine engine airfoil part after the area of the casting defect has been machined;

FIG. 23(d) is a schematic perspective view of the cast turbine engine airfoil part having the area of the casting defect being filled with a coating material;

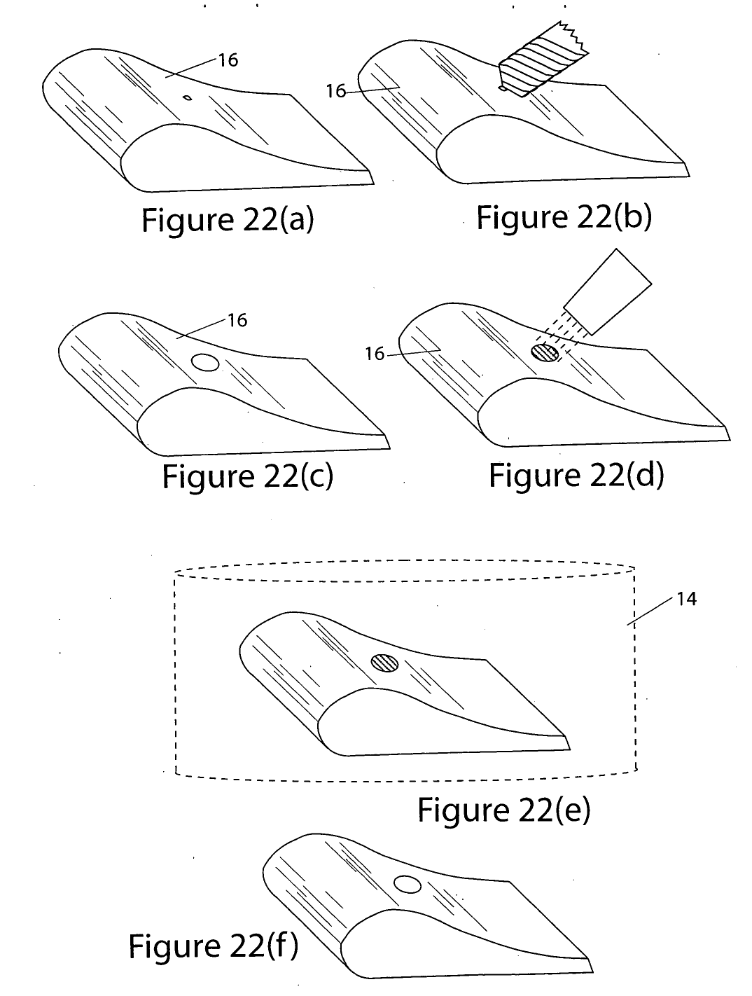

FIG. 22(e) is a schematic perspective view of the coated cast turbine engine airfoil part being subjected to a hot isostatic pressing treatment;

FIG. 22(f) is a schematic perspective view of the repaired cast turbine engine airfoil part;

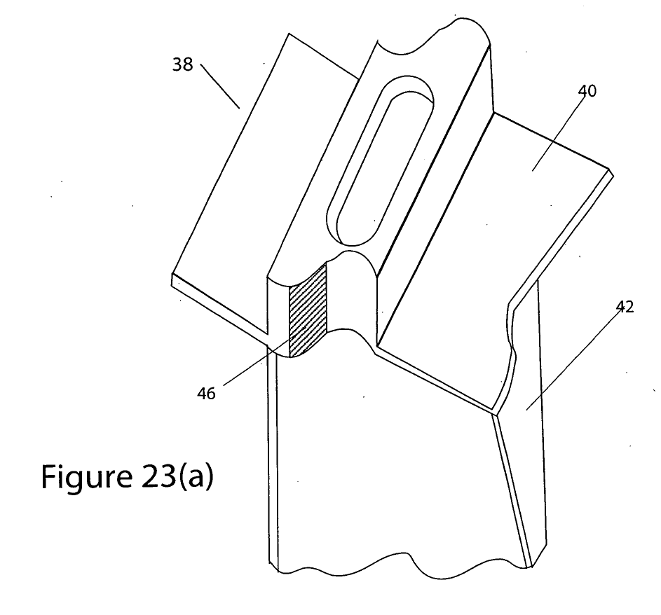

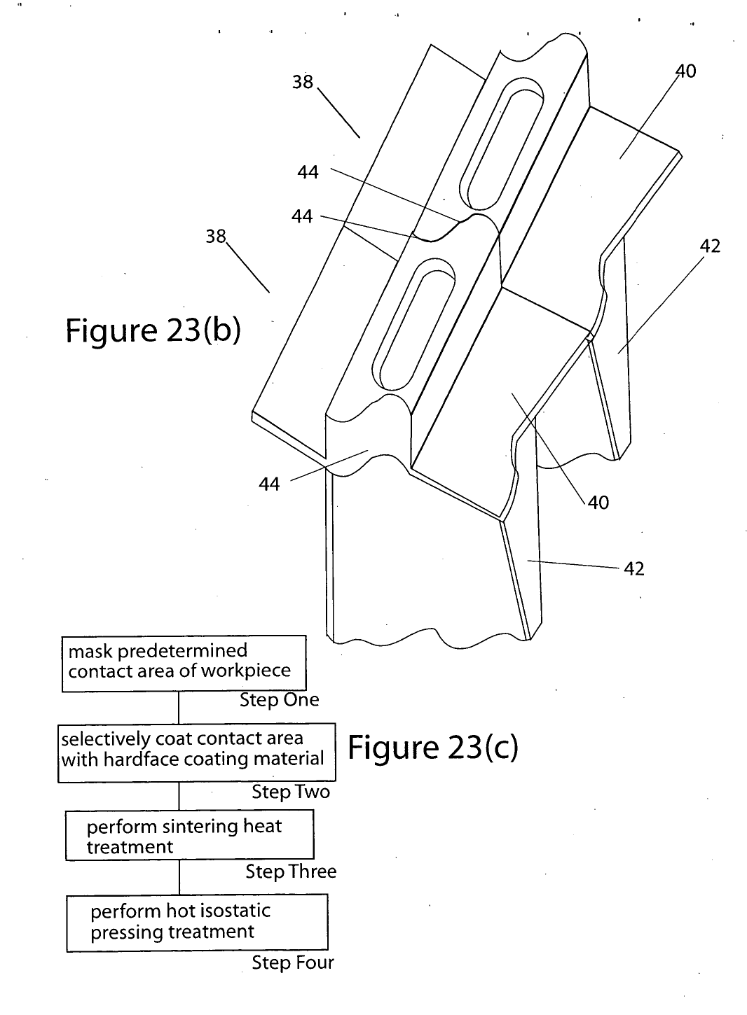

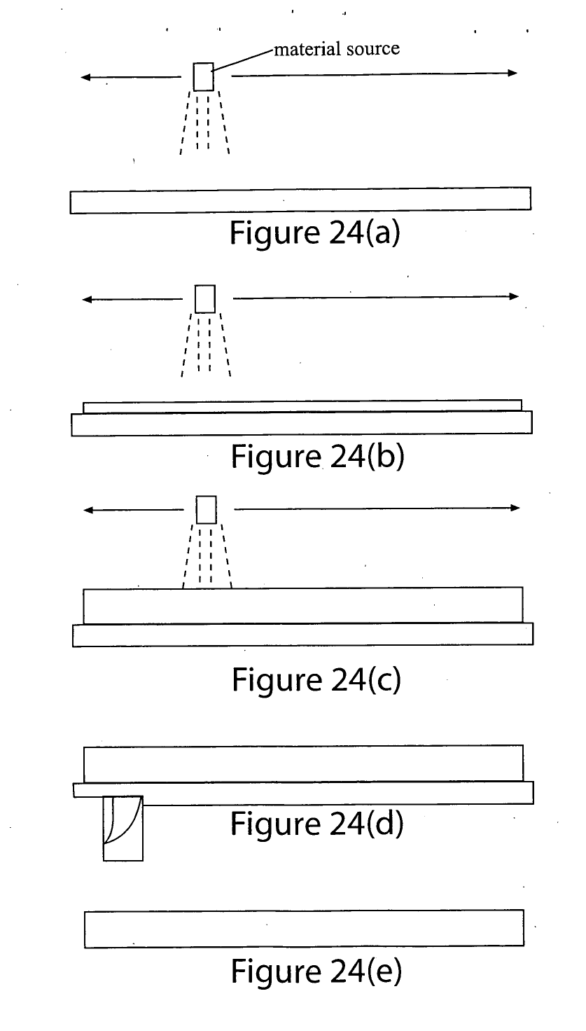

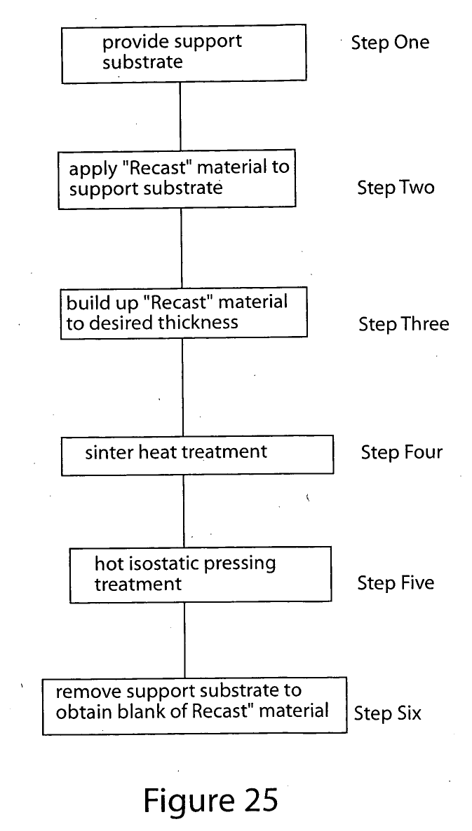

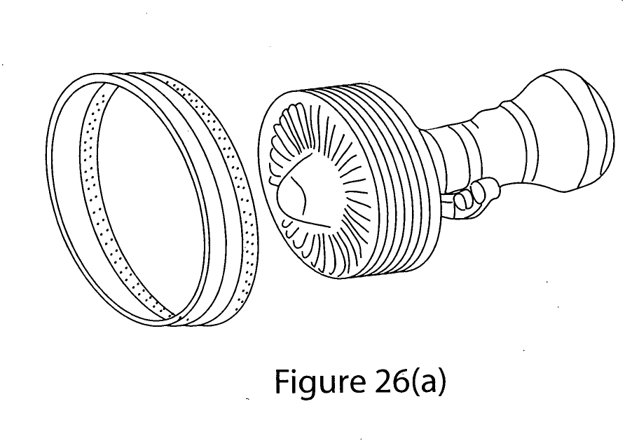

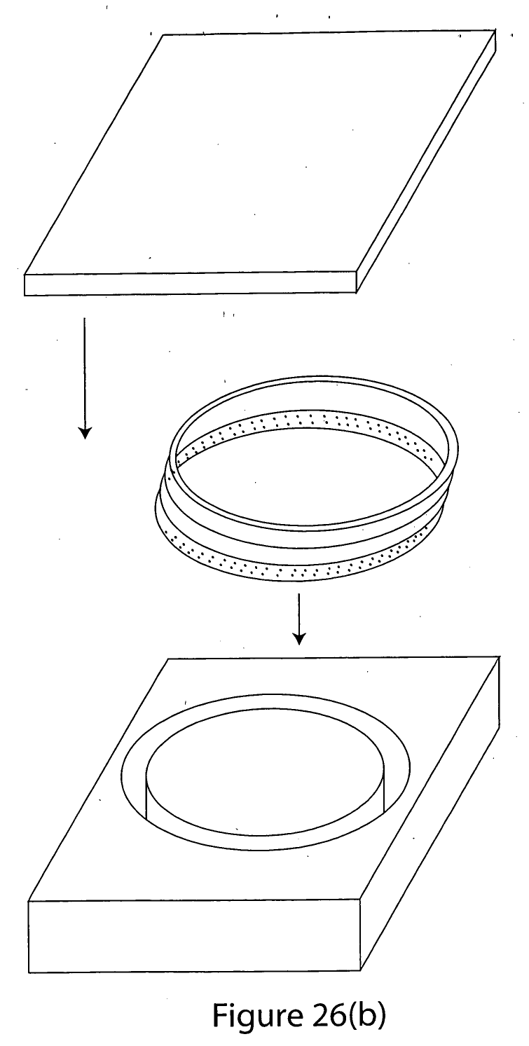

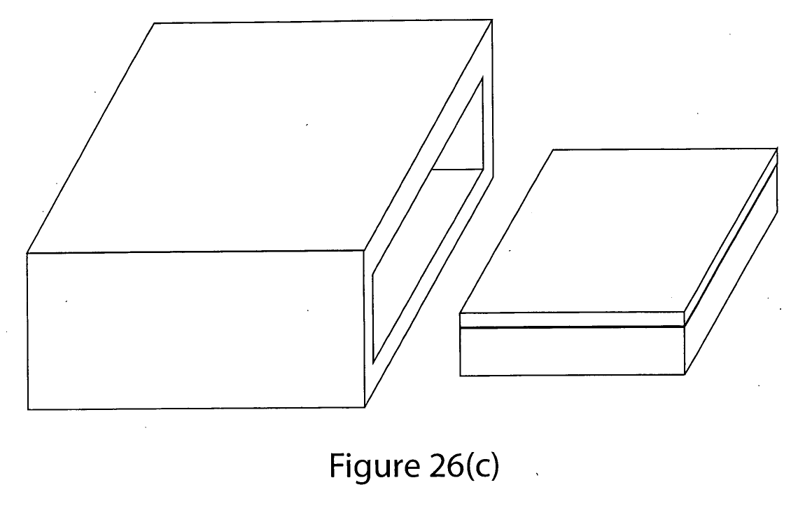

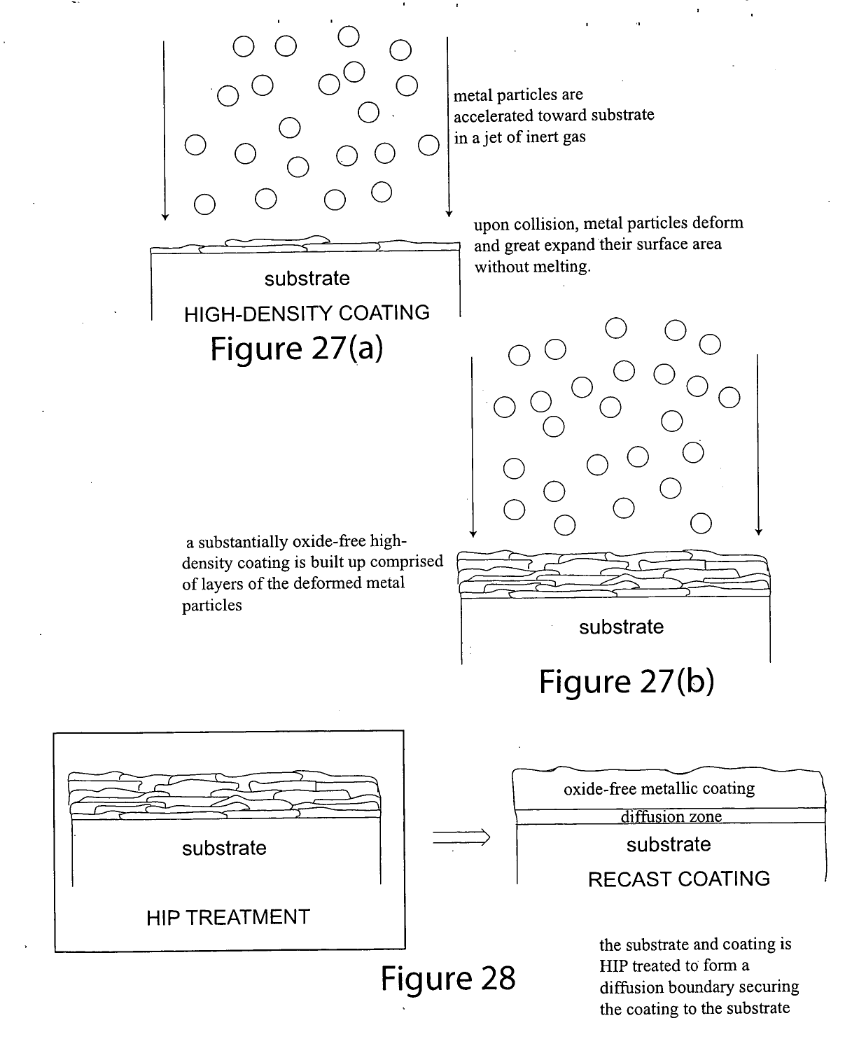

FIG. 23(a) is a cut-away view of a gas tubine engine blade showing the shroud portion afixed to the airfoil portion of the blade, and showing the location of an applied wear resistant hard facing material to the contact surface of the blade;

FIG. 23(b) shows two adjacent blades of an assembled disc showing the contact between the shrouds of the blades;

FIG. 23(c) is a flow chart illustrating the steps of the inventive method for forming a wear-resistant hard-face contact area on a workpiece, such as a gas turbine engine part;

FIG. 24(a) shows the step of forming a high-density coating on a support substrate in the inventive method for making a metallic substrate;

FIG. 24(b) shows the step of building up a desired thickness of the high-density coating in the inventive method for making a metallic substrate;

FIG. 24(c) shows the high-density coating built up to a desired thickness;

FIG. 24(d) shows the step of machining away the support substrate in the inventive method of making a metallic substrate;

FIG. 24(e) shows the inventive metallic substrate having layers of a high-density coating having a diffusion boundary between the layers;

FIG. 25 is a flow chart illustrating the steps of the inventive method for making a metallic substrate;

FIG. 26(a) shows a portion of a gas turbine engine having a containment ring;

FIG. 26(b) shows a hot isostatic pressure treatment vessel for performing a HIP treatment in accordance with the present invention;

FIG. 26(c) shows the hot isostatic pressure treatment vessel and heating oven in accordance with the present invention;

FIG. 27(a) illustrates the build up of a high density coating using a kinetic metallization process;

FIG. 27(b) illustrates the build up of a high density coating using a kinetic metallization process; and

FIG. 28 shows the high density coating formed using a kinetic metallization process being converted to a diffusion coating on the substrate.

### DETAILED DESCRIPTION OF THE INVENTION

For purposes of promoting an understanding of the principles of the invention, reference will now be made to the embodiments illustrated in the drawings and specific language will be used to describe the same. It will nevertheless be understood that no limitation of the scope of the invention is thereby intended, there being contemplated such alterations and modifications of the illustrated device, and such further applications of the principles of the invention as disclosed herein, as would normally occur to one skilled in the art to which the invention pertains.

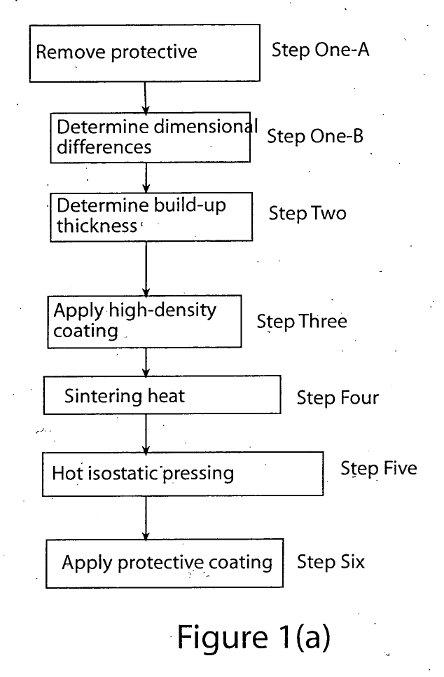

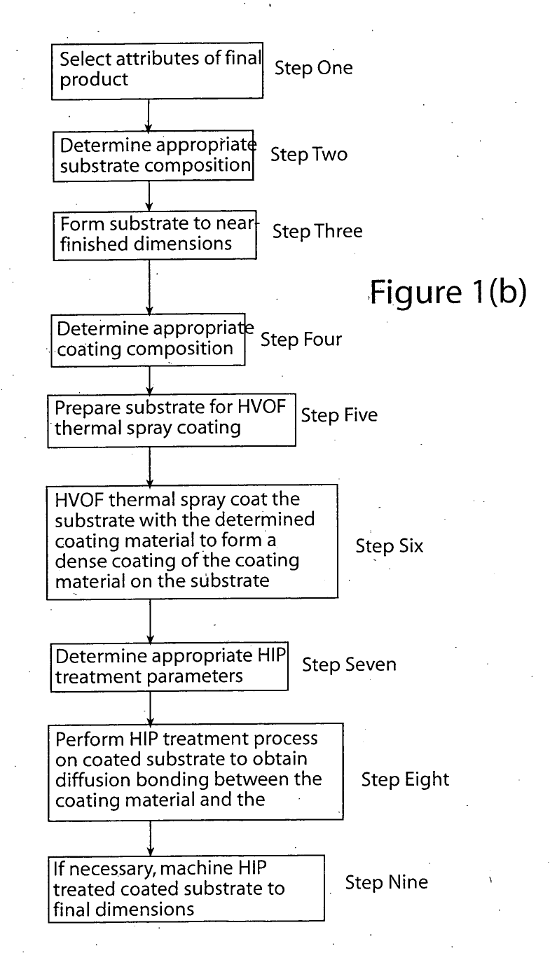

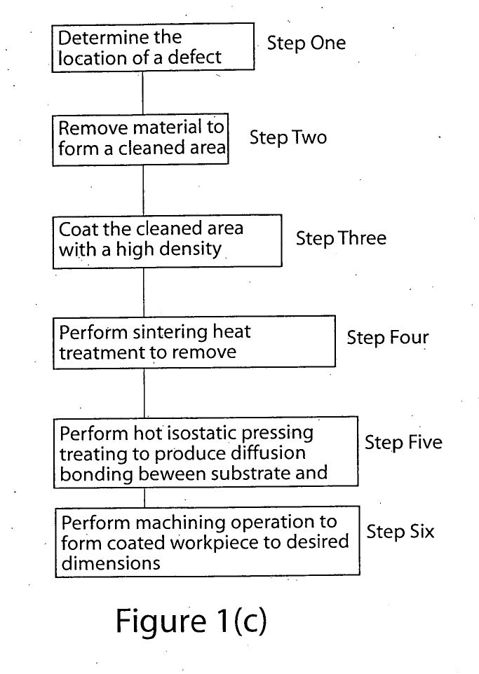

Referring to FIG. 1(a), in accordance with the present invention, the dimensional differences between pre-repaired dimensions of a turbine engine airfoil part and desired post-repair dimensions of the turbine engine airfoil part are determined (Step One-B). The turbine engine airfoil part has a substrate comprised of a superalloy. A build-up thickness of coating material required to obtain the desired post-repair dimensions of the turbine engine airfoil part is determined (Step Two). A high-density coating process, such as HVOF, is used to coat the turbine engine airfoil part with a coating material to the determined build-up thickness of coating material effective to obtain the desired post-repair dimensions after performing a sintering heat treatment and a hot isostatic pressing treatment (Step Three). The coating material comprises a metal alloy capable of forming a diffusion bond with the substrate of the turbine engine airfoil part. After the coating material is applied, a sintering heat treatment process is performed to prevent gas entrapment of the coating material and/or the diffusion bonding area during the hot isostatic pressing process (Step Four). Then, the hot isostatic pressing process is performed to obtain a post-repair turbine engine airfoil part having the desired post-repair dimensions and having diffusion bonding between the coating material and the turbine engine airfoil substrate (Step Five).

In accordance with the present invention, a protective coating must be first removed from the turbine engine airfoil part prior to performing the high-density coating process (Step One-A). After performing the hot isostatic pressing process, a protective coating may be re-applied (Step Six). In this case, the build-up thickness may be determined in Step Two to take into consideration the additional thickness of the post-repaired part due to the addition of the protective coating.

Typically, this protective coating is present on an airfoil part to protect it from the hot corrosive environment it experiences during service. This protective coating must be removed during the inspection and/or repair process. After undergoing a number of inspection and/or repair cycles, the airfoil part was conventionally discarded simply because the airfoil dimensions of the part were too deformed for the part to be usable. However, in accordance with the present inventive repair method, the airfoil dimensions are restored and a robust repaired airfoil part is obtained

In the typical application of the inventive method, the metal alloy substrate of the turbine engine airfoil part will comprise a nickel or cobalt-base superalloy. The step of performing the high-density coating process (Step Three) may thus include performing a high-density coating process such as a hyper velocity oxy-fuel thermal spray process or a detonation gun process to apply a high-density coating having the same nickel or cobalt-base superalloy composition as the metal alloy substrate.

In an embodiment of the invention in which the coating material and the substrate alloy comprise INCO713C nickel or cobalt-base superalloy, the sintering heat treatment (Step Four) comprises sintering at a temperature at or about 2150 degrees F. for about 2 hours, which has been found to effectively prevent gas entrapment of the applied high-density coating during the hot isostatic pressing process. The range at which the sintering heat treatment may be performed is about 1900 to 2300 degrees F. In the case of the nickel or cobalt-base superalloy substrate, an effective hot isostatic pressing treatment (Step Five) can be performed at a temperature of about 2200F in about 15 KSI argon for about 4 hours. The inventive process may be used with alloys of other metals, such as titanium or aluminum. The parameters of the hot isostatic pressing treatment typically call for heating the engine part to a temperature that is substantially 80% of the melting point of the metal alloy; and pressurizing the engine part to a pressure substantially between 20 and 50 percent of the yield strength of the metal alloy in an inert gas atmosphere.

The dimensional differences between the pre-repaired dimensions of the turbine engine airfoil part and the desired post-repair dimensions of the turbine engine airfoil part are measured from at least one of the cordal and length dimensions of the airfoil part (Step One-B). By performing the inventive method for repairing a gas turbine engine airfoil part, the post-repair dimensions are equal to the dimensions necessary for effectively returning the part to active service. The obtained diffusion bonding between the coating material and the substrate ensures that the repaired airfoil part is robust enough to withstand the highly demanding environmental conditions present in an operating gas turbine engine. Thus, the present invention offers substantial cost savings over having to replace a turbine gas engine airfoil part which otherwise might have been discarded.

The present invention can be used as a process for restoring critical gas path area dimensions in cast nickel or cobalt-base superalloy vane components. These dimensions may become altered due to erosion or particle strikes during the service life of the part, and/or may become altered during an inspection or repair process wherein a protective coating is stripped from the part.

The inventive process, referred to herein as “recast”, briefly consists of applying a pre-alloyed metal powder, compositionally identical to the superalloy used in the original manufacture of the vane being repaired, directly on dimensionally discrepant surfaces, densifying the metal powder coating, and causing it to bond to the affected surface.

More specifically, in the preferred embodiment of the invention candidate recast surfaces are abrasively clean, thermal sprayed using high velocity oxy fuel processes (HVOF), sintered, and hot isostatically pressed (HIPed).

Thermal spray metal powders, produced by a vacuum/inert gas atomization processes, are applied directly to the dimensionally discrepant surfaces of a turbine engine airfoil part using robotic HVOF processes carefully controlled to produce dense coatings while minimizing thermal gradients and oxidative solute losses.

Properly applied HVOF coatings are dense but sometimes contain interconnected micropores. In accordance with the present invention, such “porous” HVOF coatings are more fully densified by sintering and subsequently diffusion-bonded to substrate surfaces by HIPing at temperatures and pressures commensurate with the nickel or cobalt-base alloy under consideration.

Recast surfaces are compositionally identical to, but microstructurally different from, original or “as-cast” substrates. As-cast substrates are defined herein as a substrate formed by a conventional casting process, such as the lost wax or investment casting process described above. The microstructures of cast nickel or cobalt-base superalloy substrate materials such as used in the manufacture of gas turbine vanes generally consist of a relatively large amount of an intermetallic precipitate referred to as “gamma prime” within, and networks of carbides and borides within and around, large “gamma” matrix grains. The amount and morphology of gamma prime, carbides, and borides are determined by composition, processing history, and heat treatment.

Recast microstructures similarly consist of gamma prime, carbides, and borides precipitated in and around gamma matrix grains; but, recast matrix grains are considerably smaller than as-cast grains. Recast gamma prime, carbide and boride precipitates are similarly finer than as-cast. In addition, some of the more reactive solutes (e.g., aluminum) in the thermal spray powders oxidize during the HVOF spray process to form oxide particles which become randomly dispersed in the recast deposit.

Articles repaired by recast are best described as bimetallic composites comprised of recast coatings bonded to as-cast substrates. The mechanical properties of such repaired articles vary depending on the relative volume fraction of the recast coating, the specific alloy(s) under consideration, and processing history.

Example of Recast INCO713C/cast INCO713C Composite Mechanical Properties Obtained in Accordance with the Present Invention:

Representative tensile and stress-rupture properties of recast INC0713C/cast INC0713C composite test specimens were measured to more fully elucidate the recast process.

INCO713C was selected as the base nickel or cobalt-base superalloy for measurement because it is specified by a large number of engine manufactures for gas turbine component applications, and is bill-of-material for JT8D second-stage vanes, a candidate component for the inventive recast repair method.

Near cast-to-size INC0713C test bars were machined into ASTM proportioned mechanical test specimens with tapered (approximately three percent) gauge lengths. The average minimum gauge length diameter was 0.2137 inches.

The machined test specimens were grit-blasted with silicon carbide, ultrasonically cleaned, and robotically sprayed with INCO713C powder using Diamond Jet HVOF processes. The composition of the INC0713C powder used in these evaluations is shown in Table 1.

TABLE I
Certified Compositions of INCO713C Atomized
Powder and Cast-To-Size Test Bars

| | | | | Cast-To-Size |
|---|---|---|---|---|
| | | | | Test Bars |
| Element | EMS 55079 | | Atomized Powder | (Heat # 8616) |
| Nickel | Balance | | Balance | Balance |
| Chromium | 11.0 | to 13.0 | 13.6 | 13.67 |
| Aluminum | 5.5 | to 6.5 | 5.86 | 5.61 |
| Molybdenum | 3.8 | to 5.2 | 4.39 | 4.06 |
| Columbium | 1.5 | to 2.5 | 2.1 | 2.08 |
| Titanium | 0.4 | to 1.0 | 0.9 | 0.84 |
| Zirconium | 0.05 | to 0.15 | 0.07 | 0.05 |
| Carbon | 0.05 | to 0.07 | 0.1 | 0.13 |
| Boron | 0.005 | to 0.015 | 0.01 | 0.008 |
| Cobalt | 1.00 | max. | <0.01 | <0.05 |
| Silicon | 0.50 | max. | 0.09 | <0.05 |
| Copper | 0.05 | max. | 0.04 | <0.05 |
| Iron | 0.25 | max. | 0.18 | <0.05 |
| Manganese | 0.25 | max. | 0.01 | <0.05 |
| Sulfur | 0.015 | max. | 0.002 | <0.05 |
| Phosphorus | 0.015 | max. | | |

Sufficient HVOF coating was applied to increase the composite specimen gauge length diameter to approximately 0.250 inches. The sprayed test bars were then sintered at 2150F for 2 hours in vacuum, HIPed at 2200F in 15 KSI argon for 4 hours in a standard commercial HIP toll cycle, and tested for room temperature tensile and elevated-temperature stress-rupture.

The composite test specimens used for these measurements were nominally comprised of 28 percent recast INC0713C and 72 percent as-cast INCO713C. The recast INCO713C percentage varied, however, from 25.5 to 30.9 percent depending on precise machined and sprayed specimen dimensions.

Mechanical Properties:

The room temperature tensile and 1800F stress-rupture properties of the as-cast INCO713C core material used in these measurements are summarized in Table II.

TABLE II
INCO713C Heat #8616 Qualification Tests
1. Room Temperature Tensile

| a. | 0.2% Y.S. | 108 KSI | |
|---|---|---|---|
| | UTS | 126 KSI | |
| | Elongation | 6.0% | |
| b. | 0.2% Y.S. | 112.2 KSI | 111.0 KSI |
| | UTS | 126 KSI | 135.7 KSI |
| | Elongation | 6.3% | 6.7% |

2. Stress-Rupture

| | Temperature | Stress | Rupture Life | Elongation |
|---|---|---|---|---|
| a. | 1800 F. | 22 KSI | 30.0 hours | |
| | 1800 F. | 24 KSI | 14.8 hours | 14.0% |
| b. | 1800 F. | 22 KSI | 55.3 hours | 9.1% |
| | 1800 F. | 22 KSI | 58.2 hours | 10.3% |

The room-temperature tensile and 1800F stress-rupture properties of the 28 percent recast INCO713C composite test specimens are summarized in Table III.

TABLE III
Measured Tensile and Stress-Rupture Properties of
Composite Cast/Recast INCO713C Test Specimens
1. Room Temperature Tensile Properties

| Specimen | 0.2 YS | UTS | Elongation |
|---|---|---|---|
| #1 | 123.3 KSI | 150.3 KSI | 5.6% |
| #2 | 122.0 KSI | 151.5 KSI | 6.6% |
| #3 | 122.4 KSI | 148.1 KSI | 6.7% |
| Average | 122.4 KSI | 150.0 KSI | 6.3% |

2. Stress-Rupture Properties

| | | | |
|---|---|---|---|
| | | | Reduction |
| | | | in Area@ |
| Specimen | Rupture Life | Elongation | 1800 F./22 KSI |

(stress calculated on cast INCO713C cross-section only)

| | | | |
|---|---|---|---|
| #4 | 60.9 hrs. | 10.7% | 21.1% |
| #5 | 55.9 hrs. | 6.3% | 17.8% |
| #6 | 60.9 hrs. | 7.1% | 16.8% |

@ 1600 F./42 KSI (stress calculated on cast
INCO713C cross-section only)

| | | | |
|---|---|---|---|
| #5 | 202.5 hrs. | 6.9% | 12.2% |
| #6 | >212.5 hrs. | 4.9% | 8.6% |

The room temperature yield and ultimate tensile strengths of the 28 percent recast INCO713C composite test specimens were approximately 11 percent higher than those of as-cast INCO713C core material. The room temperature ductility of the 28 percent recast INCO713C composite test specimens was virtually identical to that of the as-cast INCO713C core material.

The as-cast INCO713C core material and the 28 percent recast INCO713C composite test specimens were tested for stress-rupture at 1800F under “constant load” conditions to experimentally assess the effect of the recast process on the sustained, high-temperature, load-bearing capacity of as-cast INCO713C.

The approximate time to rupture as-cast INCO713C at 1800F/22 KSI, as estimated from available “Larsen-Miller” correlations, is 48 hours. The time to rupture the as-cast INCO713C core material test bars at 1800F/22 KSI was 30.0 hours. The average time to rupture machined as-cast INCO713C test specimens at 1800F/22 KSI was 56.5 hours. The average as-cast INCO713C 1800F/22 KSI stress-rupture life was 45 hours, plus or minus 15 hours.

The 28 percent recast INCO713C composite test specimens were tested at 1800F under loads sufficient to produce 22 KSI stress based on as-cast INCO713C substrate dimensions rather than composite test specimen dimensions. Test loads ranged from 795 to 799 pounds (797 pounds average) depending on precise as-cast INCO713C machined diameters. Corresponding composite specimen stresses ranged from 15 to 16 KSI.

The average time to rupture the 28 percent INCO713C composite test specimens under such “constant load” test conditions was 60.9 hours at 1800F.

Data Analyses:

The data summarized in Table III show that the recast process augments the room temperature tensile properties of as-cast INCO713C.

Assuming the room temperature tensile properties of the as-cast INCO713C substrate remain unchanged by the thermal treatments associated with the recast process, “rule of mixture” analyses of the room temperature 28 percent recast INCO713C composite tensile data summarized in Table III indicate that the recast INCO713C portion of the composite has the following room temperature tensile properties:
150 KSI 0.2% yield strength
190 KSI ultimate tensile strength
5.8% elongation

The data summarized in Table III similarly show that the recast process augments the sustained high-temperature, load-bearing capacity of as-cast INCO713C.

“Load partitioning analysis”, for lack of a better description, were used to distinguish the stress-rupture strength properties of the recast INCO713C coating from those of the as-cast INCO713C substrate.

“Larsen-Miller” stress-rupture data correlation's suggest that the stress required to increase the 1800F rupture life of an as-cast INCO713C substrate specimen to 60.9 hours is only 21 KSI. The load required to develop a stress of 21 KSI, based on an average 0.2145 inch as-cast INCO713C substrate diameter, is 759 pounds. Since 797 pounds were applied to the 28 percent recast INCO713C composite specimens tested at 1800F/16 KSI, it follows that the balance of the load (39 pounds) was accommodated by the recast INCO713C coating.

Since the cross-sectional area of the recast INCO713C coating in the 28 percent recast INCO713C composite specimens was 0.0161 square inches, the recast INCO713C coating stress was 2.4 KSI. The 1800F/60.9 hour stress-rupture strength of recast INCO713C is, therefore, approximately 2.4 KSI.

Two 28 percent recast INCO713C composite test specimens were similarly tested in stress-rupture at 1600F under loads calculated to develop a stress of 42 KSI based on as-cast INCO713C substrate dimensions.

One of the 28 percent recast INCO713C composite test specimens ruptured in 202.5 hours at 1600F/42 KSI (based on as-cast substrate dimensions) while the other was arbitrarily terminated without rupture after 212.5 hours. An as-cast INCO713C test specimen might be expected to rupture in approximately 100 hours at 1600F/42 KSI.

“Load-partitioning analyses” of these 1 600F stress-rupture test results suggest that the 600F/200 hour stress-rupture strength of the recast INCO7 1 3C coating is greater than 8 KSI.

The stress-rupture properties of the recast INCO713C coating, as inferred from “load partitioning analyses”, generally correspond to those of wrought nickel or cobalt-base levels through post HIP heat treatments.

The experimental data discussed above indicate that recast INCO713C coating:

1. have intrinsically higher room temperature tensile strength than as-cast INCO713C; and,

2. have intrinsic stress-rupture strengths approximately equivalent to wrought nickel or cobalt-base alloys.

More importantly, the experimental data presented and discussed in this study convincingly demonstrate that the recast process augments the room-temperature tensile and sustained high-temperature, load-bearing capacities of as-cast INCO713C.

In accordance with another aspect of the present invention, a method of forming metal products and components having a durable wear resistant coating is provided. FIG. 1(b) is a flow chart showing the steps of the inventive method of forming metal products and metal components having a wear resistant coating. This method obtains a metal product having robust diffusion bonding occurring between a metal substrate and an applied coating. The first step of the inventive method is to determine the attributes of a final workpiece product (Step One). For example, if the final workpiece product is a cutting tool the attributes include a wear resistant surface formed on a relatively inexpensive tool substrate 10. If the final workpiece is a cast metal component, a decorative, smooth final surface may be desired on a cast substrate 16.

An appropriate substrate composition is then determined (Step Two) depending on the selected attributes. In the example of a cutting tool, the substrate composition may be high speed steel, which is relatively inexpensive to form but durable enough for its intended purpose. In the case of a cast metal component, the cast workpiece substrate can be formed from cast iron or aluminum (or other cast metal or metal alloy). A workpiece substrate is formed to near-finished dimensions (Step Three), using known processes such as casting, extruding, molding, machining, etc. An appropriate coating material 12 composition is determined depending on the selected attributes (Step Four). Again, in the example of a cutting tool the coating material 12 could be selected from a number of relatively hard and durable metals and alloys such as Cobalt, Carbide, TiN, etc. In the example of the cast metal component, aluminum oxide may be chosen to provide both a decorative and corrosion resistant surface. The selection of both the substrate and coating composition also depends on their metallurgical compatibility with each other.

The workpiece substrate is prepared for a high-density coating process (Step Five). The preparation may include cleaning, blasting, machining, masking or other like operations. Once the workpiece substrate has been prepared, a high-density coating process is performed to coat the workpiece substrate (Step Six). The coating material 12 is built-up to a thickness that is effective to obtain desired finished dimensions after performing a hot isostatic pressing treatment (described below). The high-density coating process may comprise performing a hyper velocity oxy-fuel thermal spray process. In the case of HVOF, a fuel gas and oxygen are used to create a combustion flame at 2500 to 3100° C. The combustion takes place at a very high chamber pressure and a supersonic gas stream forces the coating material 12 through a small-diameter barrel at very high particle velocities. The HVOF process results in extremely dense, well-bonded coatings. Typically, HVOF coatings can be formed nearly 100% dense, with at a porosity of about 0.5%.

The high particle velocities obtained using the HVOF process results in relatively better bonding between the coating material 12 and the substrate, as compared with other coating methods such as the Conventional Plasma spray method or the Chemical Vapor Deposition method. However, the HVOF process also forms a bond between the coating. material 12 and the substrate that occurs primarily through mechanical adhesion at a bonding interface. As will be described below, in accordance with the present invention this mechanical bond is converted to a metallurgical bond by creating a diffusion bond between the coating material 12 and the workpiece substrate. The diffusion bond does not have the interface boundary which is usually the site of failure.

The diffusion bond is created by subjecting the coated workpiece substrate to a hot isostatic pressing (HIP) treatment. The appropriate hot isostatic pressing treatment parameters are selected depending on the coating, the workpiece substrate and the final attributes that are desired (Step Seven). The hot isostatic pressing treatment is performed on the coated workpiece substrate to obtain a metal product having the desired finished dimensions and diffusion bonding between the coating material 12 and the workpiece substrate (Step Eight).

By proper formation of the workpiece substrate, the final dimensions of the finished workpiece product can be accurately achieved through the precise control of the build up of coating material 12 when the HVOF plasma spray process is performed. Alternatively, the HIP treated and HVOF coated workpiece substrate may be machined to final dimensions as necessary (Step Nine).

HIP treatment is conventionally used in the densification of cast metal components and as a diffusion bonding technique for consolidating powder metals. In the HIP treatment process, a part to be treated is raised to a high temperature and isostatic pressure. Typically, the part is heated to 0.6-0.8 times the melting point of the material comprising the part, and subjected to pressures on the order of 0.2 to 0.5 times the yield strength of the material. Pressurization is achieved by pumping an inert gas, such as Argon, into a pressure vessel 14. Within the pressure vessel 14 is a high temperature furnace, which heats the gas to the desired temperature. The temperature and pressure is held for a set length of time, and then the gas is cooled and vented.

The HIP treatment process is used to produce near-net shaped components, reducing or eliminating the need for subsequent machining operations. Further, by precise control of the temperature, pressure and time of a HIP treatment schedule a particular microstructure for the treated part can be obtained.

In accordance with the present invention, the HIP treatment process is performed on a HVOF coated substrate to convert the adhesion bond, which is merely a relatively weaker mechanical bond, to a diffusion bond, which is a relatively stronger metallurgical bond. In accordance with the present invention, an HVOF coating process is used to apply the coating material 12 having sufficient density to effectively undergo the densification changes that occur during the HIP process. A sintering heat treatment step may be performed improve the density of the coating material and prevent gas entrapment during the hot isostatic pressing treatment. If the coating material 12 and the workpiece substrate are comprised of the same metal composition, then the diffusion bonding results in a particularly seamless transition between the substrate and the coating.

FIG. 1(c) is a flow chart showing the steps of the inventive method for correcting defects in a workpiece. A location of a defect in a workpiece is determined (Step one). The defect comprises, for example, a void or an inclusion in a workpiece substrate. For example, an oxide or dirt might be introduced or formed in the workpiece during a manufacturing process. The workpiece substrate is comprised of a metal alloy. Material of the workpiece substrate at the location of the defect is removed to form cleaned area in the workpiece substrate (Step two). The cleaned area may be formed by sand or grit blasting, machining, grinding, or the like. The cleaned area in the workpiece substrate is coated with a high-density coating (Step three). A sintering heat treatment is performed on the coated workpiece substrate to remove entrapped gas from the coating material prior to a step of hot isostatic pressing treating (Step four). Then, hot isostatic pressing treating is performed on the coated workpiece to produce diffusion bonding between the workpiece substrate and the high-density coating (Step five). If necessary, after the HIP process is complete, the coated workpeice may be machined to the desired dimensions (Step six). A high-density coating process such as hyper-velocity oxy-fuel thermal spray process or a detonation gun process is used to apply the high-density coating to the substrate at the location of the cleaned area. The high-density coating may have the same metal alloy composition as the metal alloy substrate. The metal alloy substrate may comprise a nickel or cobalt-based superalloy, and the high-density coating may have the same nickel or cobalt-based super alloy composition as the metal alloy substrate.

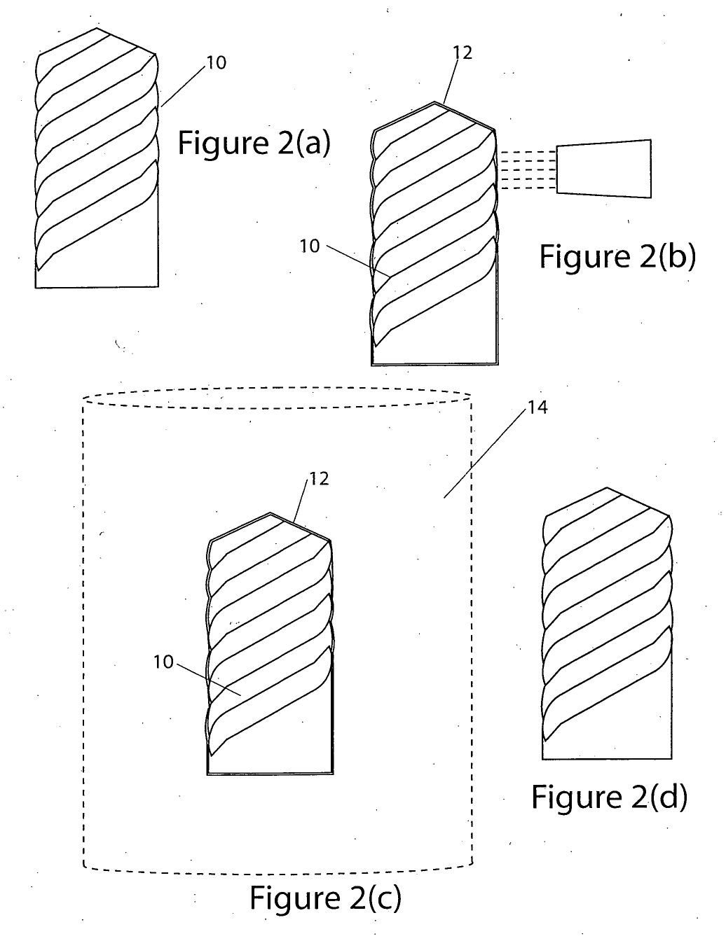

As shown in FIGS. 2(a) through 2(d), the inventive method can be used for forming a metal product having a wear resistant surface. FIG. 2(a) is a schematic view showing a tool substrate 10 provided in accordance with the inventive method of forming metal components having a wear resistant coating. The inventive method can be employed to produce, for example, a long lasting cutting tool from a relatively inexpensive cutting tool substrate 10.

In accordance with this aspect of the invention, a workpiece substrate is formed to near-finished dimensions. The tool substrate 10 may be a drill bit, end mill, lathe tool bit, saw blade, planer knifes, cutting tool inserts, or other cutting tool part. The substrate may, alternatively, be something other than a tool. For example, ice skate blades and snow ski edges may be treated in accordance with the present invention to obtain a long wearing edge. Kitchen knives may be treated in accordance with the present invention to reduce or even eliminate the need for constant sharpening. Further, products such as pen tips and fishing hooks may be treated in accordance with the present invention so as to benefit from long lasting durability. Nearly any metal component that could benefit from a longer wearing, dense surface structure might be a candidate from the present invention. For example, steam turbine erosion shields, fly ash fan blades, power plant conveyors, are all subjected to wear and/or surface erosion forces. The present invention can be used to provide the protective surface characteristics, as described herein, that enhance the effectiveness of products such as these.

FIG. 2(b) is a schematic view of the tool substrate 10 having a wear resistant coating applied using an HVOF thermal spray process in accordance with the inventive method. A high-density coating process, such as a hyper velocity oxy-fuel thermal spray process, is performed to coat the workpiece substrate 10 with a wear resistant coating material 12 using, for example, an HVOF nozzle. The coating material 12 is built-up to a thickness that is effective to obtain desired finished dimensions after performing a hot isostatic pressing treatment.

FIG. 2(c) is a schematic view of the HVOF spray coated tool substrate 10 undergoing a HIP treatment process in a HIP vessel 14. The hot isostatic pressing treatment is performed on the coated workpiece substrate to obtain a metal product having the desired finished dimensions and diffusion bonding between the coating material 12 and the workpiece substrate.

FIG. 2(d) is a schematic view of the final HVOF spray coated and HIP treated tool having a wear resistant coating layer diffusion bonded to the tool substrate 10. In accordance with the present invention the mechanical bond formed between the parent substrate and the applied coating is converted to a metallurgical bond by creating a diffusion bond between the coating material 12 and the parent substrate. The diffusion bond does not have the interface boundary which is usually the site of failure, thus a superior product is obtained that has desired surface properties, such as wear resistance, color, smoothness, texture, etc. These surface properties do not end abruptly at a bonding interface (as is the case of conventional coated or brazed products), but rather remain present to a continuously varying degree from the product surface to the parent metal. A cutting edge can be put on the tool surface by conventional sharpening techniques taking care not to remove more of the diffusion bonded coating than is necessary.

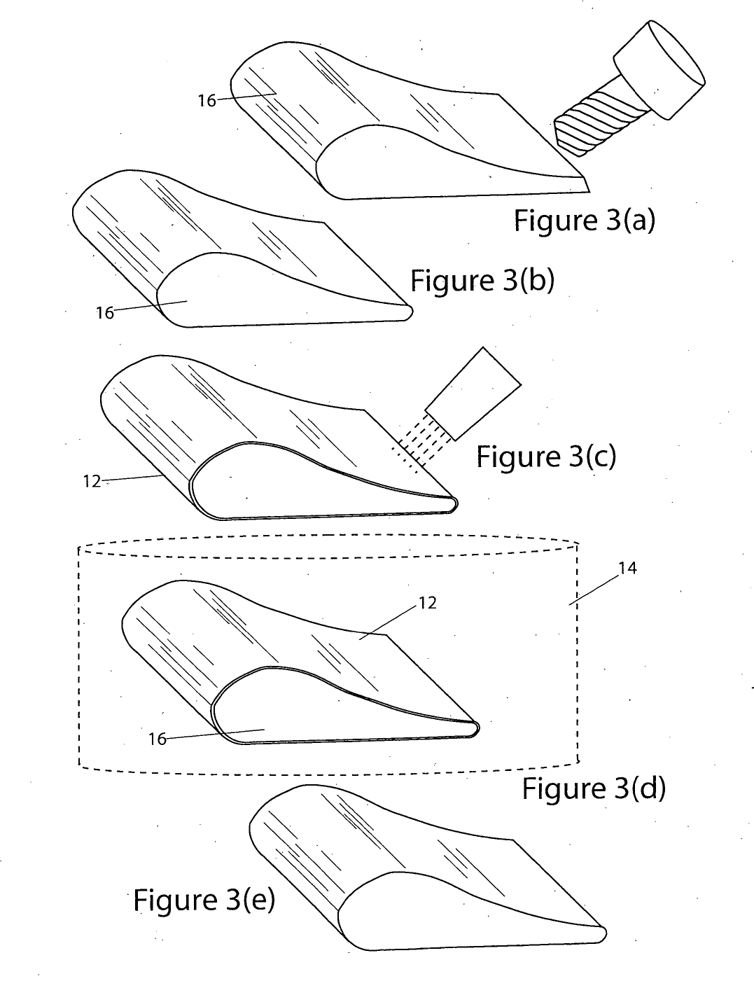

FIGS. 3(a) through 3(e) illustrate the present inventive method employed for forming a cast metal product having predetermined dimensions and surface characteristics. FIG. 3(a) is a schematic perspective view of a cast metal workpiece substrate undergoing a machining operation. As shown in FIG. 3(a), the cast metal workpiece is machined, if necessary, to near-finished dimensions. FIG. 3(b) is a schematic perspective view of the machined cast metal component.

A high-density coating process, such as a hyper velocity oxy-fuel thermal spray process, is performed to coat the workpiece substrate with a coating material 12. FIG. 3(c) is a schematic perspective view of the machined cast metal component having a coating applied using an HVOF thermal spray process. The coating material 12 is built-up to a thickness effective to obtain desired finished dimensions after performing a hot isostatic pressing treatment. FIG. 3(d) is a schematic perspective view of the HVOF spray coated machined cast metal component undergoing a HIP treatment process in a HIP vessel 14. The hot isostatic pressing treatment is performed on the coated workpiece substrate to obtain a metal product having the desired finished dimensions and diffusion bonding between the coating material 12 and the workpiece substrate. FIG. 3(e) is a schematic perspective view of the final HVOF spray coated and HIP treated machined cast metal product having a coating layer diffusion bonded to the machined cast metal component.

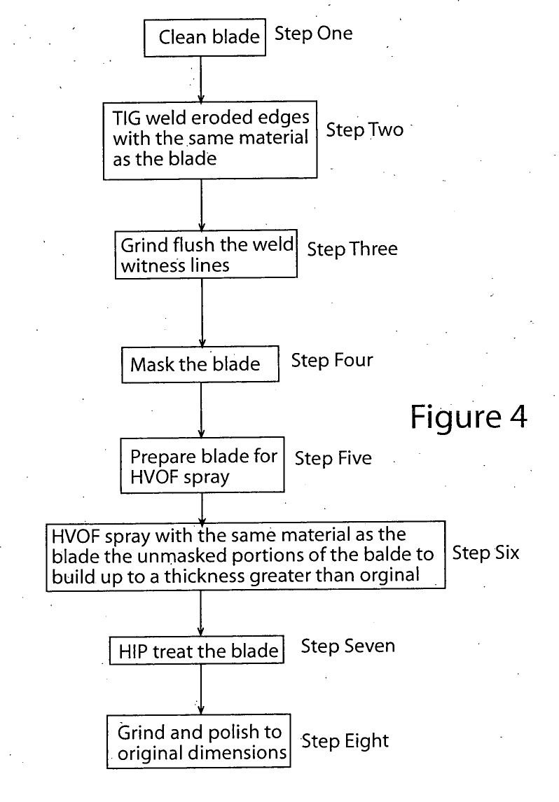

FIG. 4 is a flow chart showing the steps of the inventive method of repairing a turbine engine part. The present inventive method can be used for repairing a turbine engine part 18, such as a blade or vane. In accordance with this aspect of the invention a turbine engine part 18, which is comprised of a metal or metal alloy, is first cleaned (Step One). If necessary, eroded portions of the turbine engine part 18 are welded using a weld material comprised of the same metal or metal alloy as the parent or original metal engine part (Step Two). The welding operation is performed to build up heavily damaged or eroded portions of the turbine engine part 18. If the part is not heavily damaged, the welding operation may be obviated.

The welding operation will typically produce weld witness lines. The weld witness lines are ground flush to prevent blast material from becoming entrapped in the weld witness lines (Step Three). Portions of the engine part that are not to be HVOF sprayed are masked (Step Four), and the engine part is again cleaned in preparation for HVOF spraying (Step Five). HVOF plasma spraying of the unmasked portions of the engine part is performed (Step Six). The HVOF plasma spray material (coating material 12) is comprised of the same metal alloy as the parent or original metal engine part. The HVOF plasma spray material is applied so as to build up a cordal dimension of the engine part to a thickness greater than the thickness of an original cordal dimension of the engine part. A sintering heat treatment process may be performed to further densify the coating material. A hot isostatic pressing (HIP) treatment if performed on the coated engine part to densify the coating material 12, to create a diffusion bond between the coating material 12 and the parent and weld material, and to eliminate voids between the turbine engine part 18, the weld material and the coated material (Step Seven). Finally, the engine part is machined, ground and/or polished to the original cordal dimension (Step Eight).

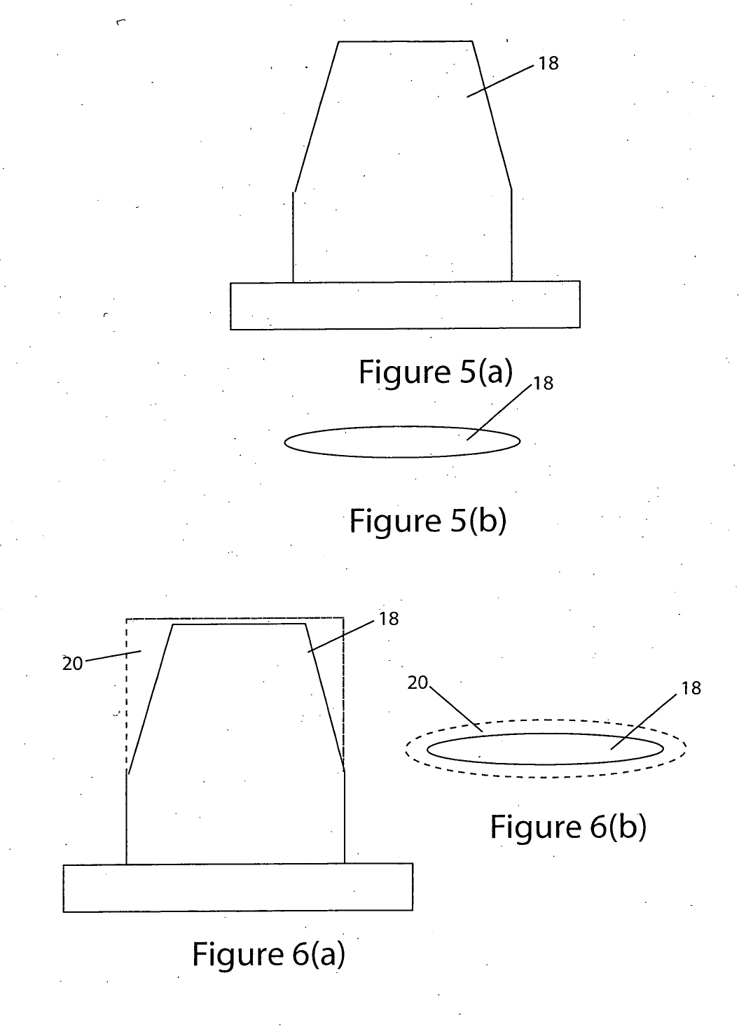

FIG. 5(a) is a schematic side view and FIG. 5(b) is a schematic cross-sectional view of a worn turbine engine part 18 before undergoing the inventive method of repairing a turbine engine part 18. Metal alloy components, such as gas turbine parts such as blades and vanes, are often damaged during use. During operation, gas turbine parts are subjected to considerable degradation from high pressure and, in the case of rotating components such as blades, centrifugal force in a hot corrosive atmosphere. The gas turbine parts also sustain considerable damage due to impacts from foreign particles. Further, during inspection and/or repair operations the engine parts are stripped of a protective diffusion coating, which usually results in the reduction of some of the substrate thickness. This degradation results in a limited service life for these parts. Since they are costly to produce, various conventional repair methods are employed to refurbish damaged gas turbine blades and vanes. However, these conventional repair methods generally require labor intensive machining and welding operations that often subject the part to damaging stress. Also, these conventional repair methods typically utilize low pressure plasma spray for the application of a coating material 12. Conventional plasma spray coating methods deposit the coating material 12 at relatively low velocity, resulting in voids being formed within the coating and in a coating density typically having a porosity of about 5.0%. Again, the bond between the substrate and the coating occurs primarily through mechanical adhesion at a bonding interface, and if the coating is subjected to sufficient shearing forces it will flake off of the workpiece substrate. Further, the high porosity of the coating obtained through conventional plasma spray coating make them inadequate candidates for diffusion bonding through the HIP treating process described herein.

FIG. 6(a) is a schematic side view and FIG. 6(b) is a schematic cross-sectional view of the worn turbine engine part 18 showing the worn areas 20 to be repaired using the inventive method of repairing a turbine engine part 18. The area enclosed by the dashed lines represent the material that has been erode or otherwise lost from the original turbine engine part 18. In accordance with the present invention, this area is reconstituted using the same material as the original blade and using the inventive metal treatment process. The worn turbine engine part 18 (in this case, a turbine blade) is first cleaned to prepare the worn surfaces for welding (see Step One, FIG. 4).

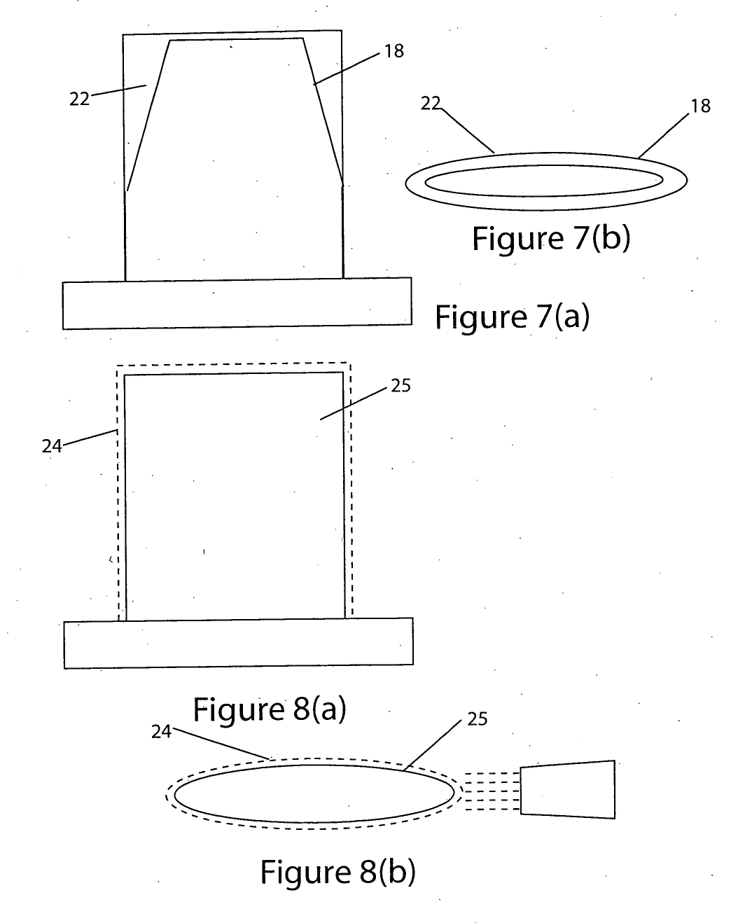

FIG. 7(a) is a schematic side view and FIG. 7(b) is a schematic cross-sectional view of the worn turbine engine part 18 showing the worn areas filled in with similar weld material 22 in accordance with the inventive method of repairing a turbine engine part 18 (see Step Two, FIG. 4). In accordance with the present invention, the weld material is the same as the original blade material making the bond between the weld and the substrate exceptionally strong.

FIG. 8(a) is a schematic side view and FIG. 8(b) is a schematic cross-sectional view of the welded turbine engine part 25 showing areas 24 to be built up with similar coating material 12 using an HVOF spray coating process in accordance with the inventive method of repairing a turbine engine part. In accordance with the present invention, the coating material 12 is the same as the original blade material, again making the bond between the weld and the substrate exceptionally strong.

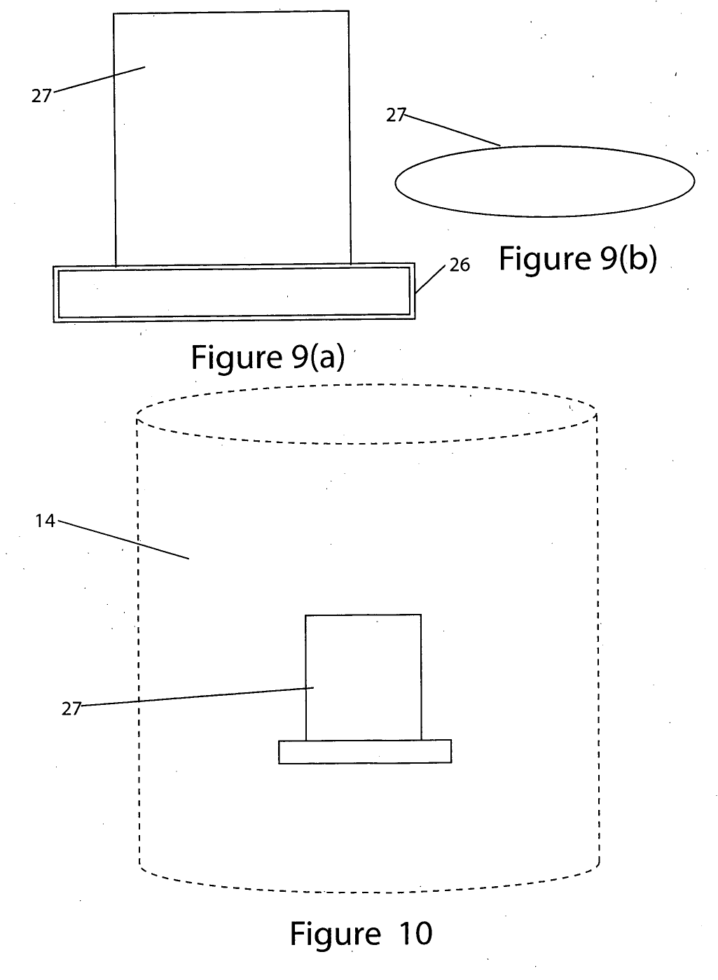

FIG. 9(a) is a schematic side view and FIG. 9(b) is a schematic cross-sectional view of the HVOF built up, welded turbine engine part 27 showing an area, such as the vane or blade root, masked 26 before performing the HVOF spray coating process in accordance with the inventive method of repairing a turbine engine part. The coating material 12 is built-up to a thickness that is effective to obtain desired finished dimensions after performing a hot isostatic pressing treatment (described below).

The high-density coating process may comprise performing a hyper velocity oxy-fuel thermal spray process. In the case of HVOF, a fuel gas and oxygen are used to create a combustion flame at 2500 to 3100° C. The combustion takes place at a very high chamber pressure and a supersonic gas stream forces the coating material 12 through a small-diameter barrel at very high particle velocities. The HVOF process results in extremely dense, well-bonded coatings. Typically, HVOF coatings can be formed nearly 100% dense, at a porosity of about 0.5%. The high particle velocities obtained using the HVOF process results in relatively better bonding between the coating material 12 and the substrate, as compared with other coating methods such as the conventional plasma spray method or the chemical vapor deposition method. However, the HVOF process forms the bond between the coating material 12 and the substrate that occurs primarily through mechanical adhesion at a bonding interface. As will be described below, in accordance with the present invention this mechanical bond is converted to a metallurgical bond by creating a diffusion bond between the coating material 12 and the workpiece substrate. The diffusion bond does not have the interface boundary which is usually the site of failure.

The diffusion bond is created by subjecting the coated workpiece substrate to a hot isostatic pressing (HIP) treatment. The appropriate hot isostatic pressing treatment parameters are selected depending on the coating, the workpiece substrate and the final attributes that are desired. The hot isostatic pressing treatment is performed on the coated workpiece substrate to obtain a metal product having the desired finished dimensions and diffusion bonding between the coating material 12 and the workpiece substrate.

FIG. 10 is a schematic view of the HVOF built up, welded turbine engine part 27 undergoing a HIP treatment process in a HIP vessel 14 in accordance with the inventive method of repairing a turbine engine part.

HIP treatment is conventionally used in the densification of cast metal components and as a diffusion bonding technique for consolidating powder metals. In the HIP treatment process, a part to be treated is raised to a high temperature and isostatic pressure. Typically, the part is heated to 0.6-0.8 times the melting point of the material comprising the part, and subjected to pressures on the order of 0.2 to 0.5 times the yield strength of the material. Pressurization is achieved by pumping an inert gas, such as Argon, into a pressure vessel 14. Within the pressure vessel 14 is a high temperature furnace, which heats the gas to the desired temperature. The temperature and pressure is held for a set length of time, and then the gas is cooled and vented.

The HIP treatment process is used to produce near-net shaped components, reducing or eliminating the need for subsequent machining operations. Further, by precise control of the temperature, pressure and time of a HIP treatment schedule a particular microstructure for the treated part can be obtained.

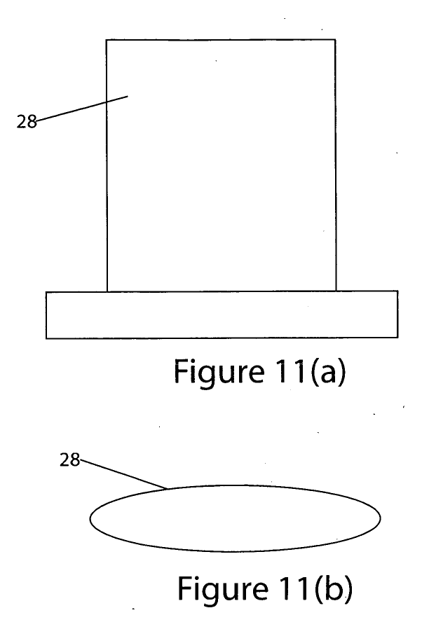

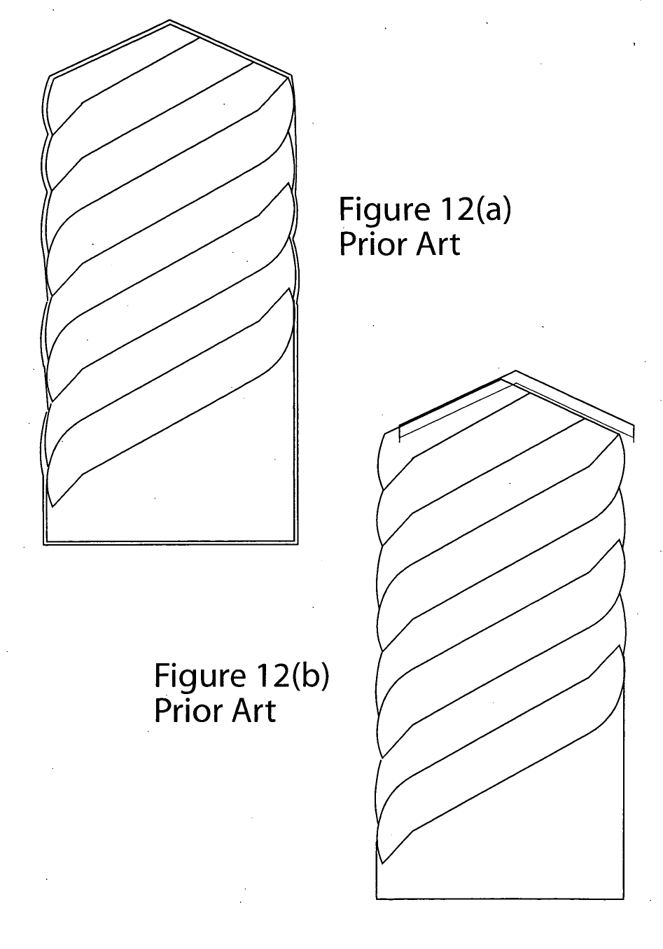

FIG. 11(a) is a schematic side view and FIG. 11(b) is a schematic cross-sectional view of the final HVOF spray coated and HIP repaired turbine engine part 28 having a similar metal coating layer diffusion bonded to the original parent substrate and welded portions in accordance with the inventive method of repairing a turbine engine part. By proper formation of the workpiece substrate, the final dimensions of the finished workpiece produce can be accurately achieved through the precise control of the build up of coating material 12 when the HVOF plasma spray process is performed. Alternatively, the HIP treated and HVOF coated workpiece substrate may be machined to final dimensions as necessary (Step Eight).

An experimental test piece was prepared in accordance with the inventive method of treating metal components. Photomicrographs of the test piece showed the grain structure and diffusion bonding of the coating material 12 and the substrate after the inventive method has been performed. The HIP treatment process was performed on an HVOF coated test substrate to convert the adhesion bond between the coating and the substrate, which is merely a mechanical bond, to a diffusion bond, which is a metallurgical bond. In accordance with the present invention, an HVOF coating process is used to apply the coating material 12 having sufficient density to effectively undergo the densification changes that occur during the HIP process. In the case of the test piece example, the coating material 12 and the workpiece substrate are comprised of the same metal composition. The diffusion bonding results in a transition between the substrate and the coating that has a much stronger structural integrity and wear characteristics as compared with the conventional art.

The test piece was prepared by building up coating material 12 to a thickness of approximately 0.02 inches, and the composition of the test pieces was determined at seven locations (A-G) across a cross section of the piece. The composition was found to be substantially uniform across the cross-section of the test piece, as shown in the following table.

TABLE I
Elemental Composition

| | (Weight %) | | | | | | |
|---|---|---|---|---|---|---|---|
| Element | A | B | C | D | E | F | G |
| Aluminum | 5.4 | 5.2 | 5.5 | 6.2 | 6.3 | 6.4 | 6.5 |
| Titanium | 0.6 | 0.6 | 1.0 | 0.6 | 1.0 | 0.6 | 0.9 |
| Chromium | 12.9 | 13.2 | 14.5 | 12.7 | 11.5 | 13.7 | 14.1 |
| Nickel | REM | REM | REM | REM | REM | REM | REM |
| Niobium | 1.4 | 1.5 | 1.8 | 2.1 | 1.7 | 2.3 | 2.6 |
| Molybdenum | 3.7 | 4.1 | 3.6 | 3.3 | 3.4 | 3.9 | 3.0 |

A photomicrograph of the treated workpiece shows the grain structure and diffusion bonding of the coating material 12 and the substrate after the inventive method has been performed. In accordance with the present invention, the HIP treatment process is performed on a HVOF built up, welded turbine engine part to convert the adhesion bond, which is merely a mechanical bond, to a diffusion bond, which is a metallurgical bond. In accordance with the present invention, an HVOF coating process is used to apply the coating material 12 having sufficient density to effectively undergo the densification changes that occur during the HIP process. If the coating material 12 and the workpiece substrate are comprised of the same metal composition, then the diffusion bonding results in smooth transition between the substrate and the coating. In contrast, a conventional plasma spray coating method results in a relatively weak bond between the coating and the substrate. The bond is primarily due to a mechanical adhesion bond that occurs relatively locally within a boundary interface.

As discussed in detail above, in accordance with the present inventive method a deformed gas turbine engine airfoil part can be returned to the dimensions required to place the part back into useful service. A diffusion bond is created between the coating material and the substrate of a repaired gas turbine engine airfoil part. This diffusion bond is extremely robust and results in a repaired engine part that has the appropriate mechanical properties that allow the part to be safely returned to service. The inventive method of repairing a turbine engine airfoil part offers substantial savings because it provides for the efficient and effective repairing of expensive engine parts which otherwise might have been discarded.

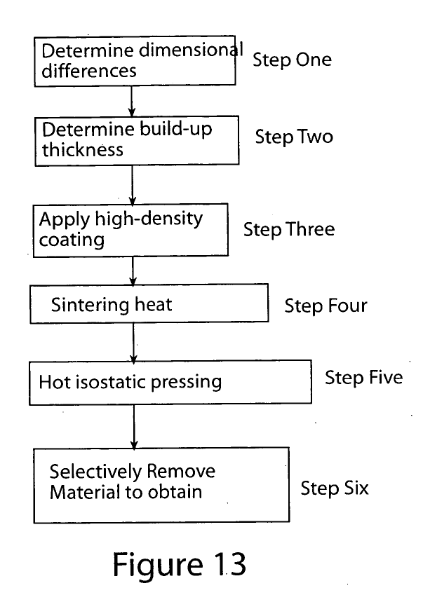

As shown in FIG. 13 in accordance with another aspect of the present invention, the reclassification of a gas turbine engine airfoil part is obtained. The dimensional differences between pre-reclassified dimensions of the buttresses of a turbine engine airfoil part and desired post-reclassified dimensions of the buttresses are determined (Step One). That is, the change in shape of the inner buttress and outer buttress necessary to obtained a desired angular relationship between the airfoil section and the buttresses is determined. Build-up thickness of coating material required to obtain the desired post-reclassified dimensions of the buttresses is determined (Step Two). A high-density coating process, such as HVOF, is used to coat the buttresses of the turbine engine airfoil part with a coating material (Step Three). The portions of the part that are not to be built up, such as the airfoil section and parts of the buttresses, may be masked before applying the high-density coating. Also, some of the coated surfaces of the part may need to be built up more than others. The coating material is applied at least to the determined build-up thickness of coating material effective to obtain the desired post-reclassification dimensions after performing a hot isostatic pressing treatment, and after the selective removal of some of the original buttress material and some of the built up coating material.

As discussed herein, the coating material comprises a metal alloy capable of forming a diffusion bond with the substrate of the turbine engine airfoil part. After the coating material is applied, the sintering heat treatment process may be performed (Step Four) to prevent gas entrapment of the coating material and/or the diffusion bonding area during the hot isostatic pressing process. Then, the hot isostatic pressing process is performed so that the buttresses of the turbine engine airfoil part have a robust diffusion bonding between the coating material and the original material of the buttresses (Step Five). Having built up the appropriate dimensions of the inner buttress and outer buttress, the reclassification of the part is obtained by selectively removing the original buttress material and, if necessary, some of the built up material until the angular relationship between the airfoil section and the inner and outer buttresses is obtained (Step Six). The material can be removed through milling, grinding, or other suitable and well known machining operations. Further, to facilitate obtaining the correct dimensions the centerline position of the airfoil part can be located and held by mounting the part in a suitable holding fixture when machining the buttresses.

The fixture may be so constructed so that a vane that has at least a minimum amount of material built up on its buttresses can be machined and reclassified. In this case, it may not be necessary to determine the dimensional differences or the required build-up thickness. Rather, the inventive high-density coating and HIPing process (and, if needed sintering) can be performed to build up at least the minimum amount of material diffusion bonded to the buttresses. Then, the vane is placed in the fixture and the excess material (both original buttress material and the built-up material) is machined until the buttresses have been reshaped and the vane reclassified as intended or restored to original.

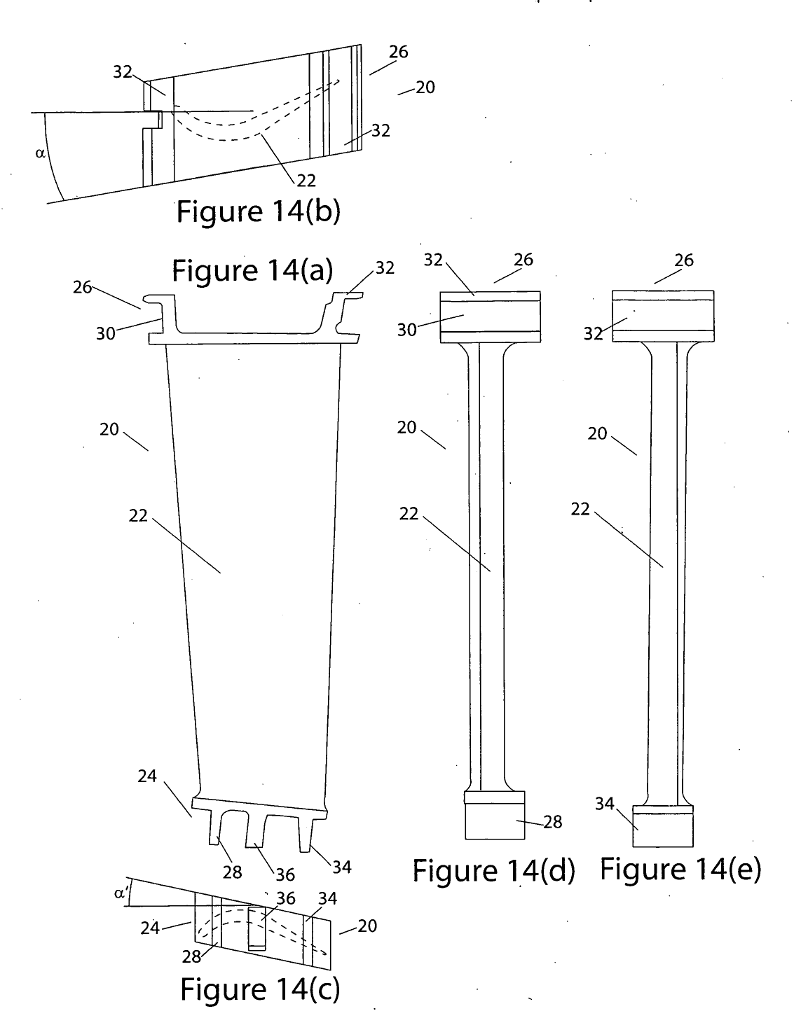

The class of a turbine engine vane is defined by the angular relationship between the airfoil section and the inner and outer buttresses. The inventive recast process is utilized to change or restore the original class of a turbine engine airfoil part by building up sufficient material on the inner buttress and the outer buttress so that the buttresses can then be machined to create the desired angles α and α′ (shown in FIGS. 14(b) and 14(c)) and reclassify the vane.

All buttresses are dimensionally the same and all airfoils are dimensionally the same for all classes of vanes. In accordance with the present invention, the airfoil centerline position is held by mounting the vane in a fixture, and the buttresses are machined to obtained to desired reclassification parameters.

The class of a turbine engine vane 20 is defined by the angular relationship between the airfoil section 22 and the inner buttress 24 and outer buttress 26. The inventive recast process is utilized to change or restore the original class of a turbine engine airfoil part by building up sufficient material on the inner buttress 24 and the outer buttress 26 so that the buttresses 24, 26 can then be machined to create the desired angles α and α′ (shown in FIGS. 14(b) and 14(c)) and reclassify the vane 20.

All buttresses 24, 26 are dimensionally the same and all airfoils are dimensionally the same for all classes of vanes. In accordance with the present invention, the airfoil centerline position is held by mounting the vane 20 in a fixture, and the buttresses 24, 26 are machined to obtained to desired reclassification parameters.

FIG. 14(a) is a front view of a vane 20 from a gas turbine engine showing the airfoil section 22, the outer buttress 26 and the inner buttress 24. In accordance with this aspect of the invention, it is first determined what dimensions of the inner buttress 24 and outer buttress 26 need to be adjusted in order to obtain the desired reclassification of the vane 20. Having determined the dimensional differences between the pre-reclassified buttresses 24, 26 and the post-reclassified buttresses 24, 26, it is next to determine how much material must be added, and where the material must be added so that the buttresses 24, 26 can be reshaped.

FIG. 14(b) is a partial top view showing the outer buttress 26 and angle α indicating the angular relationship between the airfoil section 22 and the outer buttress 26 and FIG. 14(c) is a partial bottom view showing the inner buttress 24 and angle α′ indicating the angular relationship between the airfoil section 22 and the inner buttress 24. In accordance with the present invention, the vane 20 is reclassified by changing the shape of the buttresses 24, 26 so that the angles α and α′ are changed resulting in a changed angle of attack of the airfoil section 22, and thus reclassification of the vane 20.

FIG. 14(d) is a partial left-side view showing the leading edge foot 28 of the inner buttress 24 and the outer foot front face 30 of a buttress rail 32 of the outer buttress 26 and FIG. 14(e) is a partial right-side view showing the trailing edge foot 34 of the inner buttress 24 and the other buttress rail 32 of the outer buttress 26. In accordance with the present invention, the surfaces of the buttresses 24, 26, such as the leading edge foot 28, center log 36, trailing edge foot 34 (inner buttress 24), and the outer foot front face 30 and buttress rails 32 (outer buttress 26) are selectively built up and machined so that the angle of attack of the airfoil section 22 is adjusted. The build up of material on the buttresses 24, 26 may be uniform, and then the buttresses 24, 26 machined to selectively remove portions of the original substrate and portions of the build up material. To reduce machine costs, the surfaces of the original buttresses 24, 26 that are going to be machined may be masked before the buildup material is applied. In this case, the buildup material will not have to be later machined along with the original substrate to reshape the buttresses 24, 26, 24, 26.

A fixture for holding the vane 20 during the machining operation(s) may be so constructed so that the vane 20 having at least a minimum amount of material built up on its buttresses 24, 26 can be machined and reclassified. In this case, it may not be necessary to determine the dimensional differences or the required build-up thickness. Rather, the inventive high-density coating and HIPing process (and, if needed sintering and other processes described herein) can be performed to build up at least the minimum amount of material diffusion bonded to the buttresses 24, 26, 24, 26. Then, the vane 20 is placed in the fixture and the excess material (both original buttress material and the built-up material) is machined until the buttresses 24, 26 have been reshaped and the vane reclassified as intended.

The resulting reclassified vane has inner and outer buttresses with the mechanical properties required for safe return to active service in an operating gas turbine engine. The diffusion bonding between the applied coating material built up on the buttresses and the original buttress substrate ensures, as substantiated by the test results discussed herein, that the reclassified vane can be safely returned to active service.

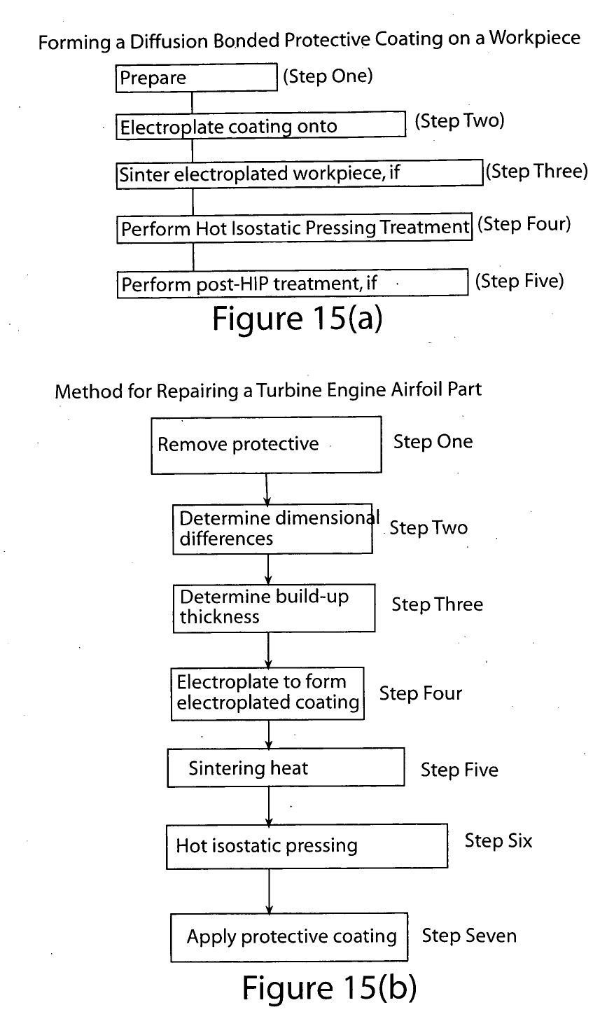

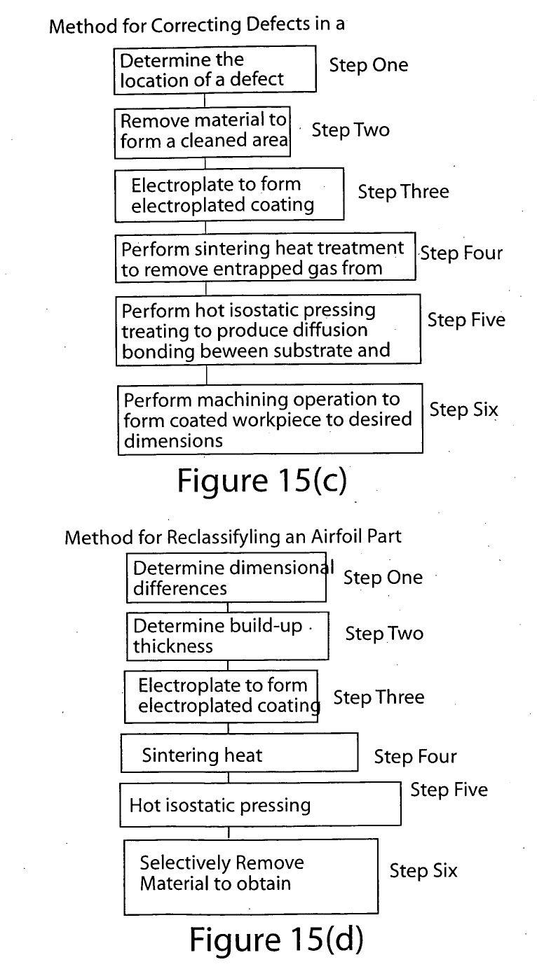

FIG. 15(a) is a flowchart showing the steps of the inventive method for repairing a workpiece with an electroplated coating diffusion bonded to the workpiece. A workpiece substrate is provided and prepared for a coating operation (Step One). The preparation may include, for example, masking off portions that are not to be coated, cleaning and machining surfaces to be coated, etc. A coating is formed on at least selected portions of the workpiece substrate through an electroplating process (Step Two). The coating material is capable of forming a diffusion bond with the workpiece substrate. The diffusion bond is a metallurgical bond between the workpiece and the coating that does not have an interface boundary. This diffusion bond creates a secure attachment between the coating and the substrate, much stronger than the mechanical bond that is originally formed between the coating and the substrate. This diffusion bond is formed through the hot isostatic pressing treatment. The diffusion bond can be formed when the coating on the substrate is dense. It may be possible to form this coating by a spray process, such as vacuum spray, detonation gun, HVOF, or by a solution process such as electroplating. To ensure a diffusion bond is formed, a sintering heat treatment may have to be first performed to densify the coating prior to the hot isostatic heat treatment step and, if necessary, to remove entrapped gas (Step Three). If the coating is not dense enough, it may flake off of the substrate during the heat and pressure of the hot isostatic treatment step. Further, applicant has found that entrapped gas is problematic because it results in a weaker, bubbled surface with an inconsistent diffusion bond between the coating and the substrate. The sintering heat treatment densifies the coating and removes entrapped gas and prevents outgassing of the trapped gas during a hot isostatic pressing treatment. This preventive treatment has been experimentally proven to greatly reduces the formation of bubbles on the surface of the coated workpiece after the hot isostatic pressing treatment. After the entrapped gas is removed by the sintering heat treatment, the hot isostatic pressing treatment is then performed to drive the coating material into the workpiece substrate (Step Four). The hot isostatic pressing treatment results in the formation of the diffusion bond so that the metallurgical bond between the workpiece and the coating is formed. Further post-HIP treatments can be performed such as heat treatments, machining operations, removing masking material, forming a protective coating over the diffusion bonded coating, etc (Step Five).

FIG. 15(b) is a flow chart showing the steps of the inventive method for repairing a gas turbine engine airfoil part with an electroplated coating diffusion bonded to the airfoil substrate. In accordance with the present invention, the protective coating on a turbine engine airfoil part is removed so that the part can be prepared for the inventive electroplating recast repair method (Step One). The dimensional differences between pre-repaired dimensions of a turbine engine airfoil part and desired post-repair dimensions of the turbine engine airfoil part are determined (Step Two). The turbine engine airfoil part has a substrate comprised of a superalloy. A build-up thickness of coating material required to obtain the desired post-repair dimensions of the turbine engine airfoil part is determined (Step Three). An electroplating process is used to coat the turbine engine airfoil part with a coating material to the determined build-up thickness of coating material effective to obtain the desired post-repair dimensions after performing a sintering heat treatment and a hot isostatic pressing treatment (Step Four). The electroplating process allows the controlled build up of material even between surfaces and around angles of the substrate that would be difficult or impossible to coat using a spray coating process. A spray coating process requires a straight line from the spary nozzle to the coated surface. When the surface has contours and/or interior portions it is difficult or impossible to coat these surfaces using a spray coating process. Even if the coating material can be sprayed into the contour or interior portion, it remains difficult or impossible to apply an even coating thickness. The electroplating process enables the coating to be applied evenly even within interior surfaces, around corners or onto contours. The coating material comprises a metal alloy capable of forming a diffusion bond with the substrate of the turbine engine airfoil part. After the coating material is applied, a sintering heat treatment process may be performed if necessary to densify the electroplated coating prior to the hot isostatic pressing process (Step Five). The electroplating process has the advantages of enabling a uniform coating to be applied to a substrate, even if the substrate has contours and interior spaces. The electroplating process may not result in trapped gas, as a spray coating process does. However, it still may be necessary to perform the sintering heat treatment in order to densify the coating, so as to prevent the coating from flaking from the substrate due to the heat and pressure of the hot isostatic pressing treatment. The hot isostatic pressing process is performed to obtain a post-repair turbine engine airfoil part having the desired post-repair dimensions and having diffusion bonding between the coating material and the turbine engine airfoil substrate (Step Six). After performing the hot isostatic pressing process, a protective coating may be re-applied (Step Seven). Typically, this protective coating is present on an airfoil part to protect it from the hot corrosive environment it experiences during service. This protective coating must be removed during the inspection and/or repair process. After undergoing a number of inspection and/or repair cycles, the airfoil part was conventionally discarded simply because the airfoil dimensions of the part were too deformed for the part to be usable. However, in accordance with the present inventive repair method, the airfoil dimensions are restored and a robust repaired airfoil part is obtained

In the typical application of the inventive method, the metal alloy substrate of the turbine engine airfoil part will comprise a nickel or cobalt-base superalloy. The step of performing the electroplating coating process (Step Four) may include performing the electroplating coating process using an electroplatable material that is effective to create a diffusion bond with the airfoil substrate after the sintering and hot isostatic pressing treatment steps.

By performing the inventive method for repairing a gas turbine engine airfoil part, the post-repair dimensions are equal to the dimensions necessary for effectively returning the part to active service. The obtained diffusion bonding between the coating material and the substrate ensures that the repaired airfoil part is robust enough to withstand the highly demanding environmental conditions present in an operating gas turbine engine. Thus, the present invention offers substantial cost savings over having to replace a turbine gas engine airfoil part which otherwise might have been discarded. The present invention can be used as a process for restoring critical gas path area dimensions in cast nickel or cobalt-base superalloy vane components. These dimensions may become altered due to erosion or particle strikes during the service life of the part, and/or may become altered during an inspection or repair process wherein a protective coating is stripped from the part.

FIG. 15(c) is a flow chart showing the steps of the inventive method for correcting defects in a workpiece with an electroplated coating diffusion bonded to the workpiece. A location of a defect in a workpiece is determined (Step one). The defect may comprise, for example, a void or an inclusion in a workpiece substrate. For example, a crack or divot may be present in the workpiece due to manufacturing or service-related problems. Or, an oxide or dirt might be introduced or formed in the workpiece during a manufacturing process. Further, a cast workpiece may have casting flaws such as surface porosity, voids, cracks, or may be undersized due to shrinkage. The invention method for correcting defects in a workpiece can be employed to correct such casting defects prior to finish machining operations. The workpiece substrate is comprised of a metal alloy. Material of the workpiece substrate at the location of the defect may be removed, if necessary, to form a cleaned area in the workpiece substrate (Step two). The cleaned area may be formed by sand or grit blasting, machining, grinding, selective etching, or the like. Parts of the workpiece that are not to be coated may then be masked.

An electroplating process is used to coat the turbine engine airfoil part with a coating material to the determined build-up thickness of coating material effective to obtain the desired post-repair dimensions after performing a sintering heat treatment and a hot isostatic pressing treatment. The electroplating process allows the controlled build up of material even between surfaces and around angles of the substrate that would be difficult to coating using a spray process. The coating material comprises a metal alloy capable of forming a diffusion bond with the substrate of the turbine engine airfoil part (Step three). A sintering heat treatment may be performed on the coated workpiece substrate to densify the coating material prior to a step of hot isostatic pressing treatment (Step four). Then, hot isostatic pressing treatment is performed on the coated workpiece to produce diffusion bonding between the workpiece substrate and the electroplated coating (Step five). If necessary, after the HIP process is complete, the masking may be removed and/or the coated workpiece may be machined to the desired dimensions (Step six).

FIG. 15(d) is a flow chart showing the steps of the inventive method for reclassifying a gas turbine engine airfoil part with an electroplated coating diffusion bonded to the airfoil part. The dimensional differences between pre-reclassified dimensions of the buttresses of a turbine engine airfoil part and desired post-reclassified dimensions of the buttresses are determined (Step One). That is, the change in shape of the inner buttress and outer buttress necessary to obtained a desired angular relationship between the airfoil section and the buttresses is determined. Build-up thickness of coating material required to obtain the desired post-reclassified dimensions of the buttresses is determined (Step Two).

An electroplating process is used to coat the turbine engine airfoil part with a coating material to the determined build-up thickness of coating material effective to obtain the desired post-repair dimensions after performing a sintering heat treatment and a hot isostatic pressing treatment. The electroplating process allows the controlled build up of material even between surfaces and around angles of the substrate that would be difficult to coat using a spray process. The coating material comprises a metal alloy capable of forming a diffusion bond with the substrate of the turbine engine airfoil part (Step three). The portions of the part that are not to be built up, such as the airfoil section and parts of the buttresses, may be masked before applying the electroplated coating. Also, some of the coated surfaces of the part may need to be built up more than others. In this case, the masking can be done in stages, so that after a build up of electroplated material occurs, a portion of the built up surface is masked before additional electroplating build is performed on the unmasked portions. The coating material is applied at least to the determined build-up thickness of coating material effective to obtain the desired post-reclassification dimensions after performing a hot isostatic pressing treatment, and after the selective removal of some of the original buttress material and some of the built up coating material.

As discussed herein, the coating material comprises a metal alloy capable of forming a diffusion bond with the substrate of the turbine engine airfoil part. After the coating material is applied, the sintering heat treatment process may be performed (Step Four) to densify the electroplated coating prior to the hot isostatic pressing process. Then, the hot isostatic pressing process is performed so that the buttresses of the turbine engine airfoil part have a robust diffusion bonding between the coating material and the original material of the buttresses (Step Five). Having built up the appropriate dimensions of the inner buttress and outer buttress, the reclassification of the part is obtained by selectively removing the original buttress material and, if necessary, some of the built up material until the angular relationship between the airfoil section and the inner and outer buttresses is obtained (Step Six). The material can be removed through milling, grinding, or other suitable and well known machining operations. Further, to facilitate obtaining the correct dimensions the centerline position of the airfoil part can be located -and held by mounting the part in a suitable holding fixture when machining the buttresses.

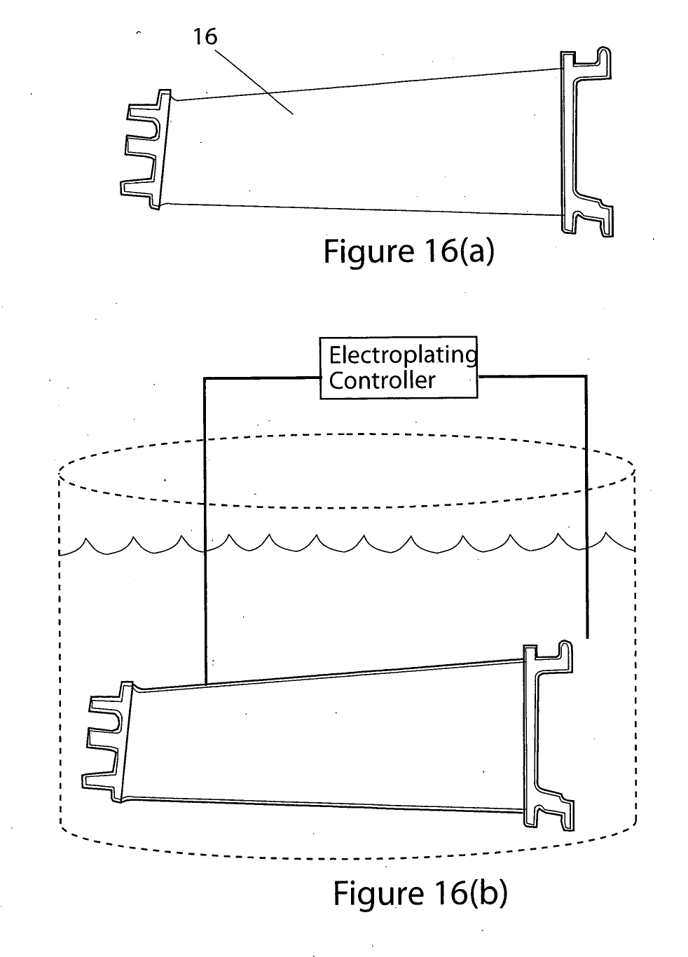

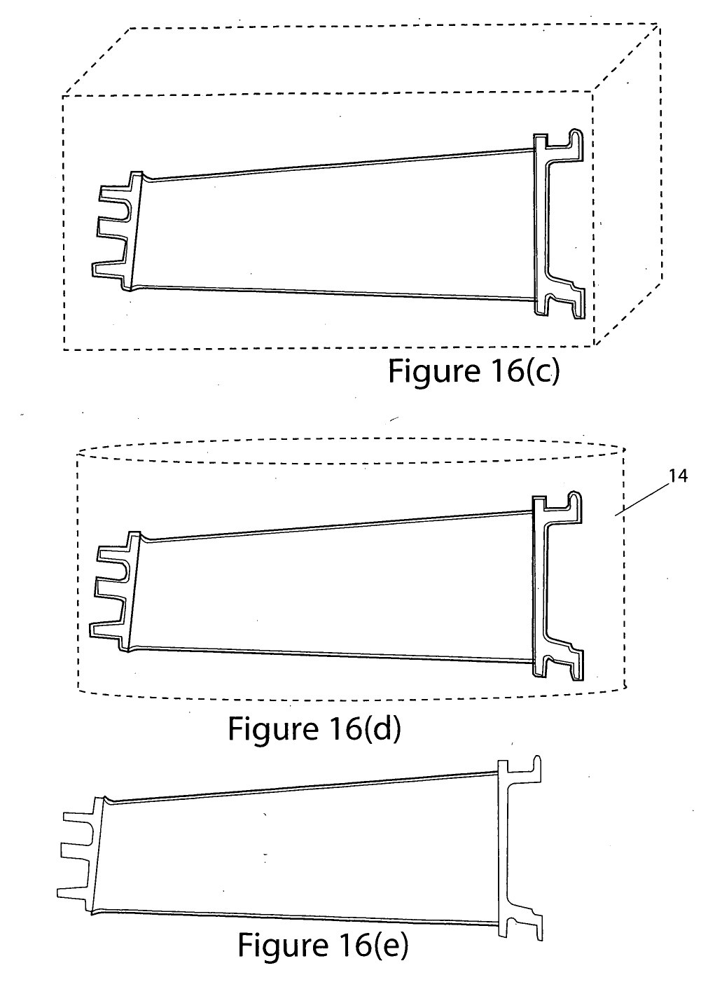

FIG. 16(a) shows an airfoil part prepared for electroplating. A workpiece substrate is provided and prepared for a coating operation. The preparation may include, for example, masking off portions that are not to be coated, cleaning and machining surfaces to be coated, etc

FIG. 16(b) shows the prepared airfoil part being electroplated. A coating is formed on at least selected portions of the workpiece substrate through an electroplating process. The coating material is capable of forming a diffusion bond with the workpiece substrate. The diffusion bond is a metallurgical bond between the workpiece and the coating that does not have an interface boundary. This diffusion bond creates a secure attachment between the coating and the substrate, much stronger than the mechanical bond that is originally formed between the coating and the substrate.

FIG. 16(c) shows the electroplated airfoil part undergoing a sintering heat treatment. A sintering heat treatment may be performed to densify the coating material (Step Three). The sintering heat treatment may be necessary to prevent the coating material from separating from the workpiece substrate under the temperature and pressure of the hot isostatic heat treatment.

FIG. 16(d) shows the sintered electroplated airfoil part undergoing a hot isostatic heat treatment. After the sintering heat treatment, the hot isostatic pressing treatment is then performed to drive the coating material into the workpiece substrate (Step Four). The hot isostatic pressing treatment results in the formation of the diffusion bond so that the metallurgical bond between the workpiece and the coating is formed.

FIG. 16(e) shows the finished airfoil part having a diffusion bond between the electroplated areas and the airfoil substrate. Further post-HIP treatments can be performed such as heat treatments, machining operations, removing masking material, forming a protective coating over the diffusion bonded coating, etc (Step Five).

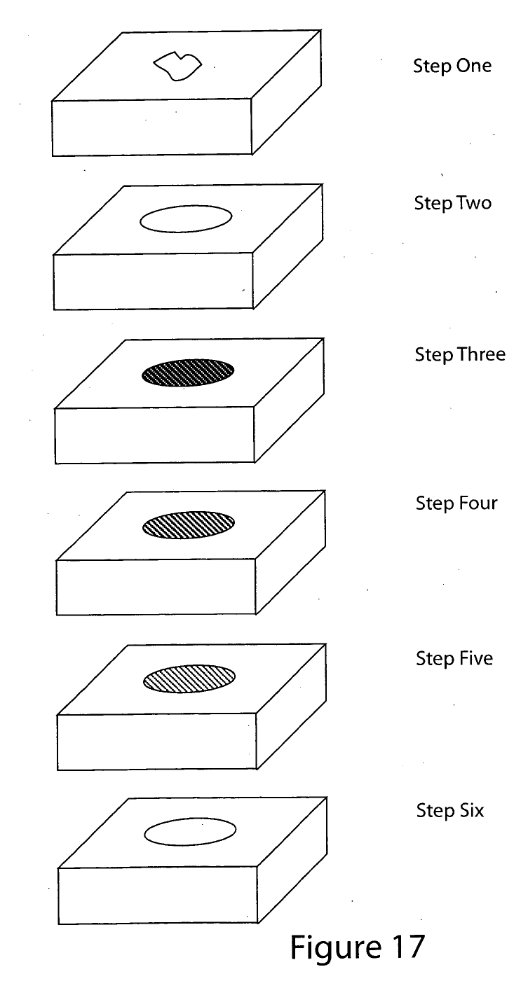

FIG. 17 illustrates the steps of correcting the dimensional characteristics of a cast article. In accordance with the present invention, a method of correcting the dimensional characteristics of a cast article is provided. As shown in Step One, the dimensional differences are determined between pre-repair cast article dimensions and desired post repair cast article dimensions to correct a casting defect in the article. The determination may be made by determining the location of a void(s) in the surface of the article. The determination may also be made by determining an amount of buildup volume required to make at least a portion of the surface of the cast article built up to the desired post repair dimensions. For example, as shown in step one, a defect consisting of an inclusion can be found on the surface of a cast article. As shown in step two, the inclusion is removed, and the substrate material in the immediate area around where the inclusion was has been removed by a machining operation such as drilling or milling. As shown in step three, the article is coated in at least an area of the casting defect with a high-density coating material capable of forming a diffusion boundary between the coating material and the article. A sintering heat treatment may be performed to remove any trapped gas and/or to densify the coating surface to prevent gas from infiltrating the coating during a hot isostatic pressing treatment (step four). As shown in step five, the hot isostatic heat treatment process is performed to form the diffusion boundary between the coating material and the article. By this method, casting defects, such as oxide inclusions, surface bubbles or undercastings can be repaired. The repaired area has filler material diffusion bonded with the casting substrate, ensuring the integrity of the repair.

Depending on the type of casting defect, material in an area of the casting defect may be removed before the step of coating the article. For example, if the casting defect is an inclusion of an undesired composition, such as an oxide or dirt particle, the inclusion and some of the base article material can be removed by a machining or other operation (step two). The area of the casting defect is enlarged, and may be contoured to create a better surface for holding the coating material. The casting defect may be caused, for example, by at least one of an inclusion at a surface of the article, an air bubble at the surface of the article, undercasting, a void and shrinkage. A sintering heat treatment can be performed (step four) before the step of performing the hot isostatic heat treatment (step five) to limit the occurrence bubbles on the surface of the coating material after an isostatic heat treatment. The sintering heat treatment may preferrably be performed at a temperature substantially the same as the temperature of the hot isostatic heat treatment.

In accordance with the present invention, the coating material may comprise an alloy with substantially no oxide forming constituents so as to avoid the formation of oxide inclusions in the coating material. In this case, the coating material may be applied using a coating process that is effective to create a coating on the surface of the article that will be diffusion bonded to the article after the hot isostatic heat treatment, without the formation of crack inducing oxides. Applicant has discovered that by preventing the formation of oxide constituents in the coating, the ductility and other desirable properties of the coating is improved. This improved ductility provides a protective barrier that may effectively prevent the propagation and the formation of cracks in the coating material, the diffusion boundary and the substrate. An example of the chemistry of a suitable non-oxide inclusion forming coating is as follows:

| Element | Percentage |
|---|---|
| Nickel | Balance |
| Chromium | 9.0 |
| Cobalt | 10.0 |
| Carbon | 0.14 |
| Molybdenum | 8.6 |
| Tungsten | 12.5 |
| Boron | 0.015 |
| Columbium | 1.0 |

As shown in step six, the coated surface of the substrate may be smoothed using a grinding or polishing operation. Thus, in accordance with the present invention, the dimensional characteristics of the cast article are corrected.

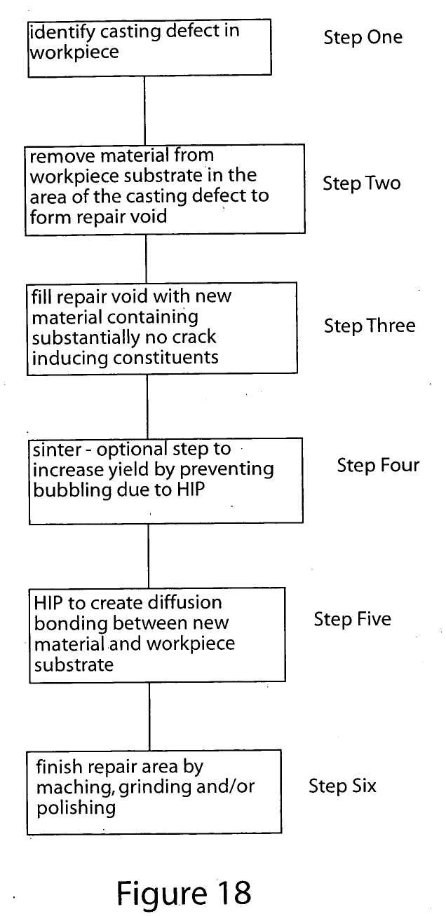

FIG. 18 is a flow chart showing the steps of the inventive method of correcting the dimensional characteristics of a cast article and for providing a protective coating to a metal article. A defect (which may be a casting defect or other defect such as wear and tear) is identified (step one). Material may be removed from the workpiece substrate as necessary (step two). For example, correcting a defect may require that the inclusion material and substrate material surrounding the inclusion be removed. A bubble may leave a semi-spherical pit which can be drilled for easier filling with the coating material. A coating material is applied at least to the area of the defect. The coating material is capable of forming a diffusion boundary between the coating material and the article. In accordance with this aspect of the invention, the coating material comprises an alloy with substantially no oxide forming constituents so as to avoid the formation of oxide inclusions in the coating material (step three). Applicants have discovered that the oxides in the coating may form crack initiation sites, and cracks formed due to the oxides may propagate through the diffusion boundary and into the article substrate. By limiting the formation of oxides in the coating, these crack initiation sites are reduced or eliminated, thereby enabling the coating material to act as a protective coating. A sintering heat treatment can be performed before the step of performing the hot isostatic heat treatment to limit the occurrence bubbles on the surface of the coating material after an isostatic heat treatment. The sintering heat treatment may be performed at a temperature substantially the same as the temperature of the hot isostatic heat treatment (step four). The hot isostatic heat treatment process is performed to form the diffusion boundary between the coating material and the article (step five). The coated surface of the substrate may be smoothed using a grinding or polishing operation (step six). Thus, in accordance with the present invention, the dimensional characteristics of the cast article are corrected, as necessary, and the substantially oxide free coating and the diffusion boundary provide a protective coating to protect the article from damage.

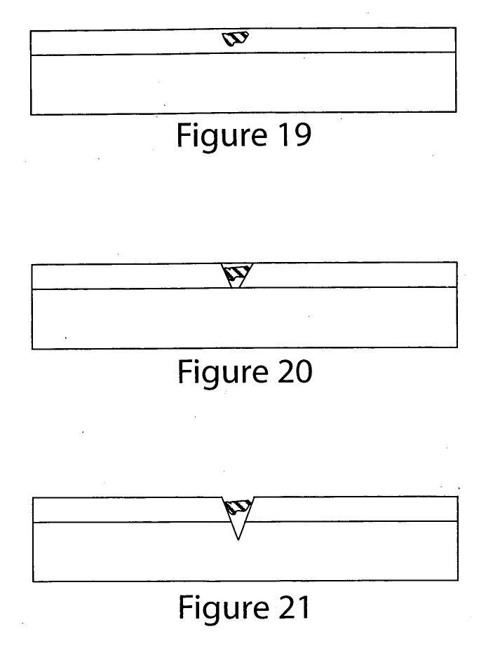

FIG. 19 schematically illustrates a coated substrate wherein the coating material is diffusion bonded to the substrate and includes an oxide inclusion. FIG. 20 schematically illustrates the coated substrate shown in FIG. 19 wherein a crack is forming at the site of the oxide inclusion. FIG. 21 schematically illustrates the coated substrate shown in FIG. 19 wherein the crack formed at the site of the oxide inclusion propagates through the diffusion boundary and into the substrate. These figures schematically illustrate the propagation of a crack caused by an oxide inclusion in a diffusion coating formed on a substrate. By removing the oxide forming materials from the coating composition, such cracks are reduced or eliminated. Further, the oxide-free coating may act as a prophylactic preventing the formation of some cracks within the substrate.

FIG. 22(a) is a schematic perspective view of a cast turbine engine airfoil part showing a casting defect. FIG. 22(b) is a schematic perspective view of the cast turbine engine airfoil part having the area of the casting defect being machined. FIG. 22(c) is a schematic perspective view of the cast turbine engine airfoil part after the area of the casting defect has been machined. FIG. 23(d) is a schematic perspective view of the cast turbine engine airfoil part having the area of the casting defect being filled with a coating material. FIG. 22(e) is a schematic perspective view of the coated cast turbine engine airfoil part being subjected to a hot isostatic pressing treatment. FIG. 22(f) is a schematic perspective view of the repaired cast turbine engine airfoil part.

As shown in FIGS. 23(a) through 23(f), in accordance with this aspect of the invention, a method is provided for repairing a turbine engine airfoil part. The dimensional differences are determined between pre-repair airfoil dimensions of a turbine engine airfoil part substrate and desired post repair airfoil dimensions of the turbine engine airfoil part substrate. The pre-repair airfoil dimensions having different airfoil characteristics than the post-repair airfoil dimensions. The turbine engine airfoil part being comprised of a metal alloy. The engine airfoil part is coated with a coating capable of forming a diffusion boundary with the turbine engine airfoil part substrate. If necessary, the engine airfoil part can be masked so that only the desired area(s) is coated. The coating material comprises an alloy with substantially no oxide forming constituents so as to avoid the formation of oxide inclusions in the coating material. In addition, or alternatively, the method of coating can be chosen so as to limit or avoid the formation of oxide inclusions. For example, the coating can be performed with the airfoil part shrouded with an inert atmosphere, such as argon gas. Or, the coating can be performed under vacuum. In any case, in accordance with this aspect of the invention, the coating material applied to repair the turbine engine airfoil part is substantially free from oxide inclusions. A hot isostatic heat treatment process is performed to obtain a post-repair turbine engine airfoil part having the desired post-repair dimensions and having a substantially oxide free coating and diffusion bonding between the coating material and the turbine engine airfoil part substrate. The substantially oxide-free coating provides a protective coating to protect the article from damage. A sintering heat treatment can be performed before the step of performing the hot isostatic heat treatment to limit the occurrence of bubbles on the surface of the coating material after an isostatic heat treatment. The sintering heat treatment may be performed at a temperature substantially the same as the temperature of the hot isostatic heat treatment.

An aspect of the present invention pertains to a method for forming a wear-resistant hard-face contact area on a workpiece, such as a gas turbine engine part. The wear resistant hardface material can be a cobalt-based hard facing alloy. The cobalt-based hard facing alloy is particularly useful as a hard facing material for gas turbine engine components, such as the shrouds of a gas turbine engine blade. Hard facing material is typically used on the critical components in gas turbine engines that are used to power jet aircraft or for the generation of electricity.

FIG. 23(a) is a cut-away view of a gas turbine engine blade showing the shroud portion afixed to the airfoil portion of the blade, and showing the location of an applied wear resistant hard facing material to the contact surface of the blade. FIG. 23(b) shows two adjacent blades of an assembled disc showing the contact between the shrouds of two adjacent blades 38 of an assembled disc. The blades are held in the housing member (not shown) such that surfaces 44 of each shroud section 40 contacts corresponding surfaces 44 of adjacent shrouds. These contact surfaces 44 are subjected to wearing forces during the operation of the gas turbine engine. As an assembled disc of blades rotates, the individual adjacent blades 38 may chatter against each other, causing wear to occur at the contact surfaces 44 of the shroud sections 40. This chattering results in constant hammering at the contact surfaces 44 of the interlocking blades 38. Excessive wear in the area of the contact surfaces 44 can have detrimental consequences on the operation of the gas turbine engine. The present invention provides a method for forming a particularly durable and effective hard facing surface to combat the excessive wear in the area of the contact surfaces of the shrouds. FIG. 23(a) shows a typical location for the application of a hard facing material 46. Typically, such hard facing material is applied to the shroud by, for example, manual tig welding or laser welding. These methods result in a mechanical bond being formed between the hard face material and the shroud substrate. This mechanical bond is subject to failure due to chipping or flaking, causing chattering between the shrouds of the assembled disk, and ultimatlely can cause failure of the entire gas turbine engine.

In accordance with the present invention, the wear resistant hardface surface is permanently adhered to the shroud substrate through a diffusion bond. Due to the nature of the diffusion bond, as described herein, the wear resistant hardface material will not chip or flake off, resulting in better service life and possibly will prevent the untimely failure of the gas turbine engine and serious detrimental consequences.

In accordance with the invention described in applicants co-pending U.S. patent application, Ser. No. 10/021,107, which is incorporated by reference herein, a cobalt-based alloy is provided that is particularly useful as a hard facing material for gas turbine engine components, such as the shrouds of a gas turbine engine blade. The alloy compositions as described in this co-pending application have a relatively small lanthanum addition and relatively large carbon content and provide remarkable oxidation resistance and wear resistance at high temperatures. Importantly, the inventive alloy composition has a suitable combination of ductility and wear resistance at high temperatures to be effective as a hard face material for limiting the effects of chattering of blades during the operation of a gas turbine engine. Accordingly, the inventive alloy has a suitable combination of ductility, oxidation resistance and wear resistance and thus represents an improved hard facing material for the blade components of gas turbine engine. The hardface coating material may comprise, for example, an alloy characterized by improved oxidation and wear resistance at elevated temperatures consisting essentially in weight percent of about:

| | Percent |
|---|---|
| Carbon | 0.07-1.00 |
| Manganese | 1.00 |
| Silicon | 1.00 |
| Chromium | 26.00-30.00 |
| Nickel | 4.00-6.00 |
| Tungsten | 18.00-21.00 |
| Boron | .005-0.100 |
| Vanadium | 0.75-1.25 |
| Iron | 3.00 |
| Lanthanum | 0.02-0.12 |
| Cobalt | remainder |

Alternatively, the hardface coating material may comprise, for example, an alloy characterized by improved oxidation and wear resistance at elevated temperatures consisting essentially in weight percent of about:

| | Percent |
|---|---|
| Carbon | 0.08 max |
| Silicon | 3.00-3.80 |
| Phosphorus | 0.03 max |
| Sulfur | 0.03 max |
| Chromium | 16.50-18.50 |
| Molybdenum | 27.00-30.00 |
| Nickel + Iron | 3.00 max |
| Nitrogen | 0.07 max |
| Oxygen | 0.05 max |
| Lanthanum | 0.02-0.12 |
| Cobalt | remainder |

FIG. 23(c) is a flowchart illustrating the steps of the inventive method for forming a wear-resistant hard-face contact area on a workpiece, such as a gas turbine engine part. In accordance with the present invention, a method is provided for forming a wear-resistant hardfaced contact area on the shroud section of a gas turbine engine blade. A predetermined contact area of a shroud section of a gas turbine engine blade is selectively coated with a high-density hardface coating material (step two). The hardface coating material is capable of forming a diffusion boundary between the hardface coating material and the shroud section. A hot isostatic heat treatment process is performed to form the diffusion boundary between the hardface coating material and the shroud section to form a wear-resistant hardfaced contact area diffusion bonded to the shroud section (step three).

Depending on the coating process, and the necessity for doing so, the predetermined contact area can be masked off before the step of selectively coating (step one). A sintering heat treatment can be perfomed before the step of performing the hot isostatic heat treatment to limit the occurrence bubbles on the surface of the hardface coating material after the isostatic heat treatment step (step four). The sintering heat treatment may be performed at a temperature substantially the same as the temperature of the hot isostatic heat treatment. The hardface coating material may comprise an alloy with substantially no oxide forming constituents so as to avoid the formation of oxide inclusions in the coating material.

FIG. 24(a) shows the step of forming a high-density coating on a support substrate in the inventive method for making a metallic substrate. The metallic substrate formed in accordance with the inventive method is built up through a high-density coating process and then HIP treated to create a multilayered structure with a diffusion boundary between at least some of the layers. FIG. 24(b) shows the step of building up a desired thickness of the high-density coating in the inventive method for making a metallic substrate. FIG. 24(c) shows the high-density coating built up to a desired thickness. FIG. 24(d) shows the step of machining away the support substrate in the inventive method of making a metallic substrate. FIG. 24(e) shows the inventive metallic substrate having layers of a high-density coating having a diffusion boundary between the layers. FIG. 25 is a flow chart illustrating the steps of the inventive method for making a metallic substrate. A support structure is provided (step one). A high-density coating is formed on the support structure (step two). Multiple layers of the high-density coating are formed to build up the material to a desired thickness (step three). Next, a sintering heat treatment process may be performed (step four). A hot isostatic pressing treatment is then performed (step five). Finally, the support substrate is removed to obtain a material blank comprised of the built-up and HIPed material (step six).

In accordance with another aspect of the present invention, a method is provided for repairing a cold section component of a gas turbine engine. As shown in FIG. 26(a), a cold section component includes an engine component known as a containment ring. A containment ring is typically made of a material such as ams4117 aluminum alloy and is known as 6061 t-6 with the following chemistry 1.0 mg, 0.60 si, 0.28 cu, 0.20 cr. The containment ring is provided annularly around the fan blade assembly. In the event of a fan blade failure, the containment ring is designed to contain the shrapnel effect of the failure thus preventing penetration into the aircraft. A typical containment ring has a diameter of about 96 inches.

In accordance with the present invention, a method is provided of repairing a cold section component, such as a containment ring, for a gas turbine engine. As shown in FIG. 26(b), a hot isostatic pressure treatment vessel is provided for performing a HIP treatment on a containment ring of a gas turbine engine. The treatment vessel is constructed so that it defines an interior chamber volume. The interior chamber volume has dimensions and geometry that are substantially the same as the dimensions and geometry of a containment ring that is to be repaired. A high-density coating is formed on at least a portion of the containment ring. As described elsewhere herein, the high-density coating is a coating that is effective for form a diffusion boundary with the coated substrate during a hot isostatic pressing heat treatment.

The coated containment ring is disposed in the interior chamber volume. The interior chamber volume is filled with an inert gas, such as argon. The interior volume chamber is raised to a temperature effective to bring the coating into a plastic state. The argon gas in the interior volume is then maintained at a temperature and pressure effective to form a diffusion boundary between the coating and the containment ring substrate. The pressure range is between 15 PSI and 30 KPSI, depending on the composition of the part being repaired and the composition of the high-density coating. By this inventive method, it is now possible to perform a repair operation on a large article, comprised of a relatively soft metal, such as aluminum. An example of an article that can be repaired in accordance with the inventive method is the containment ring of a gas turbine engine.

A sintering heat treatment step can be performed prior to forming the diffusion boundary between the coating and the containment ring substrate. The sintering heat treatment step is performed to prevent the formation of bubbles on the surface of the containment ring after the HIP treatment. The sintering heat treatment may also facilitate the ultimate formation of a tenacious diffusion boundary attachment of the coating material to the repair article substrate.

In accordance with the present invention, the dimensions and geometry of the interior chamber volume is slightly larger than containment ring. This enables a minimum of argon to be needed to fill the volume, while still providing for the appropriate heated gas applied pressure and temperature necessary for forming a diffusion boundary. For example, in the case of a containment ring, the interior chamber defines a ring shape. The hot isostatic pressure chamber thus includes an interior core surrounded by the interior chamber volume and an exterior housing surrounding the interior chamber. Either or both of the interior core and the exterior housing may include hollow structures for allowing a fluid to flow through and control heating and cooling rates of the interior chamber volume. For example, a temperature controlled fluid jacket can be provided for the controlled cooling of the containment ring after the HIP treatment or a subsequent heat treatment step, such as annealing.

As shown in FIG. 26(c), the gas in the interior volume may be maintained at a temperature and pressure by providing an oven. The oven has a heating chamber with dimensions and geometry effective to receiving the hot isostatic treatment vessel. The hot isostatic treatment vessel is placed inside the oven and the oven is sealed. The heating of the heating chamber is controlled so that the gas in the interior volume is raised and maintained at the temperature and pressure effective to form the diffusion boundary. It is specifically noted that the cold section component described herein can be substituted for many other articles in need of repair of other treatment. Traditional HIP vessels are not designed to contain very large or off-sized articles. In accordance with the present invention, articles can now be HIP treated that could not have otherwise been done. In addition, the inventive method results in a tenacious diffusion boundary between the coating and the repaired part, which also could not have been performed using traditional equipment.

FIG. 27(a) illustrates the build up of a high density coating using a kinetic metallization process. FIG. 27(b) illustrates the build up of a high density coating using a kinetic metallization process. FIG. 28 shows the high density coating formed using a kinetic metallization process being converted to a diffusion coating on the substrate.

The present invention pertains to a method of repairing a turbine engine airfoil part is provided that uses kinetic metallization to form a high density coating. This high density coating is capable of being HIP treated so as to form a diffusion bond between the repaired part the applied coating. The significant reduction or elimination of oxides formed using kinetic metallization results in an improved repaired turbine engine airfoil part, at a cost savings as compared with other methods for forming an oxide coating, which typically require the use of a costly vacuum chamber.

In accordance with this aspect of the present invention, a method of repairing a turbine engine airfoil part includes the step of first determining dimensional differences between pre-repaired dimensions of a turbine engine airfoil part and desired post-repair dimensions of the turbine engine airfoil part. The turbine engine airfoil part has a metal alloy substrate. A build-up thickness is determined of coating material that is required to obtain the desired post-repair dimensions of the airfoil part. A high-density coating process is performed to coat the turbine engine airfoil part substrate with a coating material to build-up a thickness of coating material effective to obtain desired finished dimensions after performing a hot isostatic pressing treatment. The high density coating process comprises the steps of accelerating metal particles in an inert carrier gas, and directing the accelerated metal particles onto the turbine engine airfoil part so that high-speed collision of the metal particles causes deformation of the particles resulting in a large increase in the surface area of the particles producing the controlled buildup of a high density coating of the deformed metal particles. The hot isostatic pressing treatment is performed to obtain a post-repair turbine engine airfoil part having the desired post-repair dimensions and having diffusion bonding between the coating material and the turbine engine airfoil substrate.

With respect to the above description, it is realized that the optimum dimensional relationships for parts of the invention, including variations in size, materials, shape, form, function, and manner of operation, assembly and use, are deemed readily apparent and obvious to one skilled in the art. All equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described. Accordingly, all suitable modifications and equivalents may be resorted to, falling within the scope of the invention.

1) A method of repairing a turbine engine airfoil part, comprising the steps of: determining dimensional differences between pre-repaired dimensions of a turbine engine airfoil part and desired post-repair dimensions of the turbine engine airfoil part, the turbine engine airfoil part having a metal alloy substrate; determining a build-up thickness of coating material required to obtain the desired post-repair dimensions of the airfoil part; performing a high-density coating process to coat the turbine engine airfoil part substrate with a coating material to build-up a thickness of coating material effective to obtain desired finished dimensions after performing a hot isostatic pressing treatment, the high density coating process comprising the steps of accelerating metal particles in an inert carrier gas and directing the accelerated metal particles onto the turbine engine airfoil part so that high-speed collision of the metal particles causes deformation of the particles resulting in a large increase in the surface area of the particles producing the controlled buildup of a high density coating of the deformed metal particles; performing the hot isostatic pressing treatment to obtain a post-repair turbine engine airfoil part having the desired post-repair dimensions and having diffusion bonding between the coating material and the turbine engine airfoil substrate.

2) A method of repairing a turbine engine airfoil part according to claim 1; further comprising the step of removing a protective coating from the turbine engine airfoil part prior to performing the high-density coating process.

3) A method of repairing a turbine engine airfoil part according to claim 1; wherein the metal particles have the same composition as the turbine engine airfoil part substrate.

4) A method of repairing a turbine engine airfoil part according to claim 1; further comprising the step of performing a sintering heat treatment prior to the step of performing the hot isostatic pressing treatment.

5) A method of repairing a turbine engine airfoil part according to claim 1; wherein the dimensional differences between the pre-repaired dimensions of the turbine engine airfoil part and the desired post-repair dimensions of the turbine engine airfoil part are measured from at least one of the cordal and thickness dimensions of the airfoil part.

6) A method of repairing a turbine engine airfoil part, comprising the steps of: determining dimensional differences between pre-repair cordal dimensions of a turbine engine airfoil part substrate and desired post-repair cordal dimensions of the turbine engine airfoil part, the post-inspection-turbine engine airfoil part being comprised of a metal alloy; coating the engine part using a high-density coating process and a coating material comprised of the same metal alloy so as to build up the cordal dimensions of the turbine engine airfoil part to at least a desired post-repair cordal dimension of the turbine engine airfoil part, the high density coating process comprising the steps of accelerating a coating material composed of metal particles in an inert carrier gas and directing the accelerated metal particles onto the turbine engine airfoil part so that high-speed collision of the metal particles causes deformation of the particles resulting in a large increase in the surface area of the particles producing)the controlled buildup of a high density coating of the deformed metal particles without melting said metal particles; performing a hot isostatic pressing treating the turbine engine airfoil part to produce diffusion bonding between the turbine engine airfoil part and the coating material.

7) A method of repairing a turbine engine airfoil part according to claim 6; further comprising the steps of welding eroded portions of the turbine engine airfoil part using a weld material comprised of the same metal alloy, the welding process producing weld witness lines; grinding flush the weld witness lines to prevent blast material from becoming entrapped in the weld witness lines; masking portions of the turbine engine airfoil part that are not to be coated in the high-density coating process; and selectively removing portions of at least one of the weld material and the coating material to obtain the desired cordal dimension of the turbine engine airfoil part.

8) A method of repairing a turbine engine airfoil part according to claim 6; wherein the post inspection turbine engine airfoil part comprises a non-rotating engine part having a superalloy substrate and the coating material has the same alloy composition as the superalloy substrate.

9) A method of repairing a turbine engine airfoil part according to claim 6; further comprising the step of performing a sintering heat treatment prior to the step of performing the hot isostatic pressing treatment.

10) A method of repairing a turbine engine airfoil part, comprising the steps of: determining dimensional differences between pre-repaired dimensions of a post-inspection turbine engine airfoil part and desired post-repair dimensions of the turbine engine airfoil part, the turbine engine airfoil part having a substrate comprised of a superalloy; determining a build-up thickness of coating material required to obtain the desired post-repair dimensions of the turbine engine airfoil part; performing a high-density coating process to coat the turbine engine airfoil part with a coating material to build-up a thickness of coating material effective to obtain desired post repair dimensions after performing a sintering heat treatment process and a hot isostatic pressing treatment, the coating material comprising a metal alloy capable of forming a diffusion bond with the substrate, the high density coating process comprising the steps of accelerating a coating material composed of metal particles in an inert carrier gas and directing the accelerated metal particles onto the turbine engine airfoil part so that high-speed collision of the metal particles causes deformation of the particles resulting in a large increase in the surface area of the particles producing the controlled buildup of a high density coating of the deformed metal particles without melting said metal particles; performing the sintering heat treatment on the turbine engine airfoil part to densify the coating material; and then performing the hot isostatic pressing process to obtain a post-repair turbine engine airfoil part having the desired post-repair dimensions and having diffusion bonding between the coating material and the turbine engine airfoil substrate.

11) A method of repairing a turbine engine airfoil part according to claim 10; wherein the post inspection turbine engine airfoil part comprises a non-rotating engine part having a superalloy substrate and the coating material has the same alloy composition as the superalloy substrate.

12) A method of repairing a turbine engine airfoil part according to claim 10; wherein the step of hot isostatic pressing treating comprises the step of heating the engine part to a temperature that is substantially 80% of the melting point of the metal alloy; and pressurizing the engine part to a pressure substantially between 20 and 50 percent of the yield strength of the metal alloy in an inert gas atmosphere.

13) A method of repairing a turbine engine airfoil part according to claim 10; wherein the dimensional differences between the pre-repaired dimensions of a turbine engine airfoil part substrate and the desired post-repair dimensions of the turbine engine airfoil part are measured from at least one of the cordal and length dimensions of the airfoil part.

14) A method of repairing a turbine engine airfoil part according to claim 10; wherein the coating material built-up during the high-density coating process is comprised of the same material as the turbine engine airfoil part substrate.

15) A method of repairing a turbine engine airfoil part according to claim 10; wherein the turbine engine airfoil part comprises a rotating engine part.

16) A method of repairing a turbine engine airfoil part according to claim 10; wherein the superalloy substrate comprises a nickel or cobalt-base superalloy.
